(19) United States
(12) Patent Application Publication
(10) Pub. No.: US 2015/0296509 A1
(43) Pub. Date: Oct. 15, 2015

(54) METHOD FOR TRANSCEIVING CONTROL SIGNAL, AND APPARATUS THEREFOR

(71) Applicant: LG ELECTRONICS INC., Seoul (KR)

(72) Inventors: Suckchel Yang, Anyang-si (KR); Hakseong Kim, Anyang-si (KR); Joonkui Ahn, Anyang-si (KR); Dongyoun Seo, Anyang-si (KR)

(73) Assignee: LG ELECTRONICS INC., Seoul (KR)

(21) Appl. No.: 14/647,047

(22) PCT Filed: Nov. 22, 2013
(86) PCT No.: PCT/KR2013/010686

§ 371 Date: May 22, 2015

Related U.S. Application Data
(60) Provisional application No. 61/751,232, filed on Jan. 10, 2013.
(60) Provisional application No. 61/731,450, filed on Nov. 29, 2012.
(60) Provisional application No. 61/729,423, filed on Nov. 23, 2012.

(51) Int. Cl. H04W 72/04; H04W 76/04; H04L 5/14; H04L 5/00

(52) U.S. Cl. CPC H04W 72/0446; H04L 5/0055; H04W 76/048; H04W 72/042; H04L 5/1438

(57) ABSTRACT

The present invention relates to a method for transmitting a signal by a terminal in a wireless communication system in which a plurality of cells including first and second cells are combined, and to an apparatus therefor. The method includes the steps of: receiving a first physical downlink shared channel (PDSCH) through a first cell and a second PDSCH through a second cell in a specific time period; and transmitting a control signal providing instructions for an acknowledgement (ACK)/negative acknowledgment (NACK)response to the first PDSCH and an ACK/NACK response to the second PDSCH, wherein when the first PDSCH includes a random access response, the ACK/NACK response to the first PDSCH or the first cell is determined as a discontinuous transmission (DTX) or NACK.

### TECHNICAL FIELD

The present invention relates to a wireless communication system, and more particularly, to a method and apparatus for efficiently transmitting and receiving an uplink control signal.

### BACKGROUND ART

Recently, wireless communication systems are widely developed to provide various kinds of communication services including audio communications, data communications and the like. Generally, a wireless communication system is a kind of a multiple access system capable of supporting communications with multiple users by sharing available system resources (e.g., bandwidth, transmission power, etc.). For instance, multiple access systems include CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

### DISCLOSURE

### Technical Problem

An object of the present invention is to provide a method and apparatus for effectively transmitting and receiving an uplink control signal in a wireless communication system.

Another object of the present invention is to provide a method and apparatus for effectively processing a feedback signal to a random access response in a system in which a plurality of carriers is aggregated.

Still another object of the present invention is to provide a method and apparatus for effectively transmitting and receiving a feedback signal when a random access response and other data are simultaneously transmitted in a system in which a plurality of timing advance groups is formed.

It will be appreciated by persons skilled in the art that that the objects to be achieved by the present invention are not limited to what has been particularly described above and other technical objects of the present invention will be clearly understood from the following detailed description taken in conjunction with the accompanying drawings.

### Technical Solution

In an aspect of the present invention, provided herein is a method of transmitting a signal by a user equipment (UE) in a wireless communication system in which a plurality of cells comprising a first cell and a second cell are aggregated, the method comprising: receiving a first physical downlink shared channel (PDSCH) through the first cell and a second PDSCH through the second cell in a specific time interval; and transmitting an control signal indicting an acknowledgement (ACK)/negative acknowledgment (NACK) response to the first PDSCH and an ACK/NACK response to the second PDSCH, wherein, when the first PDSCH comprises a random access response, an ACK/NACK to the first PDSCH or the first cell is determined as discontinuous transmission (DTX) or NACK.

Preferably, the wireless communication system may be a frequency division duplex (FDD) system, and the specific time interval may correspond to one subframe.

Preferably, the wireless communication system may be a time division duplex (TDD) system, and the specific time interval may correspond to one or more subframes.

Preferably, the method further comprises receiving a physical downlink control channel (PDCCH) for scheduling the first PDSCH through the first cell, wherein, when the PDCCH is masked with an identifier for random access, a power control command included in the PDCCH may not be applied to a power for transmission of the control signal.

Preferably, the power for transmission of the control signal may be determined using a total number of received transport blocks, and when the PDCCH is masked with the identifier for random access, the number of transport blocks received through the first PDSCH may be excluded from calculation of the total number of the received transport blocks.

In another aspect of the present invention, provided herein is a user equipment (UE) for transmitting a signal in a wireless communication system in which a plurality of cells comprising a first cell and a second cell are aggregated, the UE comprising: a radio frequency (RF) unit; and a processor, wherein the processor is configured to receive a first physical downlink shared channel (PDSCH) through the first cell and a second PDSCH through the second cell in a specific time interval via the RF unit, and transmit an control signal indicting an acknowledgement (ACK)/negative acknowledgment (NACK) response to the first PDSCH and an ACK/NACK response to the second PDSCH via the RF unit, and when the first PDSCH comprises a random access response, an ACK/NACK to the first PDSCH or the first cell is determined as discontinuous transmission (DTX) or NACK.

Preferably, the wireless communication system may be a frequency division duplex (FDD) system, and the specific time interval may correspond to one subframe.

Preferably, the wireless communication system may be a time division duplex (TDD) system, and the specific time interval may correspond to one or more subframes.

Preferably, the processor may be further configured to receive a physical downlink control channel (PDCCH) for scheduling the first PDSCH through the first cell via the RF unit, and when the PDCCH is masked with an identifier for random access, a power control command included in the PDCCH may not be applied to a power for transmission of the control signal.

Preferably, the power for transmission of the control signal may be determined using a total number of received transport blocks, and when the PDCCH is masked with the identifier for random access, the number of transport blocks received through the first PDSCH may be excluded from calculation of the total number of the received transport blocks.

### Advantageous Effects

According to the present invention, an uplink control signal can be effectively transmitted and received in a wireless communication system.

According to the present invention, a feedback signal to a random access response can be effectively processed in a system in which a plurality of carriers is aggregated.

In addition, according to the present invention, a feedback signal can be effectively transmitted and received when a random access response and other data are simultaneously transmitted in a system in which a plurality of timing advance groups is formed.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 illustrates an E-UMTS system.

FIGS. 2 and 3 illustrate layers of a radio protocol.

FIG. 4 illustrates physical channels and a general method for transmitting signals on the physical channels in the LTE(-A) system.

FIG. 5 illustrates a random access procedure.

FIG. 6 illustrates a structure of a radio frame used in an LTE(-A) system.

FIG. 7 illustrates a resource grid of one DL slot used in an LTE(-A) system.

FIG. 8 illustrates a downlink subframe structure used in the LTE(-A) system.

FIG. 9 illustrates a control channel allocated to a downlink subframe.

FIG. 10 illustrates a structure of a UL subframe in the LTE(-A) system.

FIG. 11 is a diagram illustrating a transmitting procedure of TDD UL ACK/NACK in a single cell situation.

FIG. 12 illustrates an example of ACK/NACK transmission using DL DAI.

FIG. 13 illustrates a carrier aggregation (CA) communication system.

FIG. 14 illustrates an exemplary scheduling, when a plurality of carriers are aggregated.

FIG. 15 illustrates an example of uplink-downlink timing relation.

FIG. 16 illustrates examples in which 2 component carriers with different frequency characteristics are aggregated.

FIG. 17 illustrates an example of configuring timing advance groups for serving cells having similar timing advance characteristics.

FIGS. 18 and 19 illustrate flowcharts of a method of configuring and transmitting ACK/NACK according to the present invention.

FIG. 20 illustrates a base station and a UE to which the present invention is applicable.

### DETAILED DESCRIPTION

The following embodiments of the present invention can be applied to a variety of wireless access technologies, for example, code division multiple access (CDMA), frequency division multiple access (FDMA), time division multiple access (TDMA), orthogonal frequency division multiple access (OFDMA), single carrier frequency division multiple access (SC-FDMA), and the like. CDMA may be embodied through wireless (or radio) technology such as universal terrestrial radio access (UTRA) or CDMA2000. TDMA may be embodied through wireless (or radio) technology such as global system for mobile communication (GSM)/general packet radio service (GPRS)/enhanced data rates for GSM evolution (EDGE). OFDMA may be embodied through wireless (or radio) technology such as institute of electrical and electronics engineers (IEEE) 802.11 (Wi-Fi), IEEE 802.16 (WiMAX), IEEE 802-20, and evolved UTRA (E-UTRA). UTRA is a part of universal mobile telecommunications system (UMTS). 3^{rd} generation partnership project (3GPP) long term evolution (LTE) is a part of E-UMTS (Evolved UMTS), which uses E-UTRA. LTE-Advanced (LTE-A) is an evolved version of 3GPP LTE.

For clarity of explanations, the following description focuses on 3GPP LTE(-A) system. However, technical features of the present invention are not limited thereto. Further, a particular terminology is provided for better understanding of the present invention. However, such a particular terminology may be changed without departing from the technical spirit of the present invention.

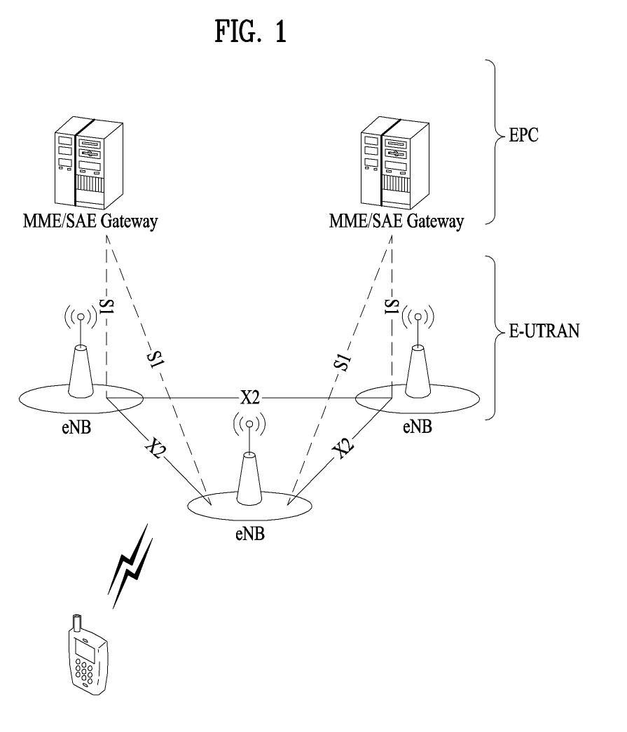

FIG. 1 illustrates an E-UMTS system. The E-UMTS system comprises a user equipment (UE), a base station, and an access gateway (AG) which is located at the end of a network (E-UTRAN) and connected to an external network. In general, a base station may simultaneously transmit multiple data streams for a broadcast service, multicast service, and/or a unicast service. An access gateway may be divided into a part for processing user traffics and a part for processing control traffics. In this case, an access gateway for processing user traffics and an access gateway for processing control traffics may communicate with each other using a new interface between them. There are one or more cells for one eNB. An interface for transmitting user traffics or control traffics may be used between eNBs. A core network may comprise an access gateway and a network node for user registration of UE. An interface for distinguishing E-UTRAN and a core network may be used. An access gateway manages mobility of a UE on the basis of tracking area. A tracking area comprises a plurality of cells, and a UE notifies an access gateway that a tracking area thereof has been changed when the UE moves from a specific tracking area to another tracking area.

E-UTRAN system is a system evolved from the conventional UTRAN system. The E-UTRAN may comprise an Evolved NodeB (eNB, base station), and eNBs are connected through X2 interface. X2 user plane interface (X2-U) is defined between eNBs. X2-U interface provides non-guaranteed delivery of user plane PDUs. X2 control plane interface (X2-CP) is defined between two neighboring eNBs. X2-CP performs functions such as a context delivery between eNBs, control of user plane tunnel between a source eNB and a target eNB, delivery of handover related messages, management of uplink load, and the like. eNB is connected with a UE through radio interface, and connected with Evolved Packet Core (EPC) through S1 interface. S1 user plane interface (S1-U) is defined between eNB and serving gateway (S-GW). S1 control plane interface (S1-MME) is defined between eNB and mobility management entity (MME). S1 interface performs functions such as EPS (Evolved Packet System) bearer service management, NAS (Non-Access Stratum) signaling transport, network sharing, MME load balancing, and the like.

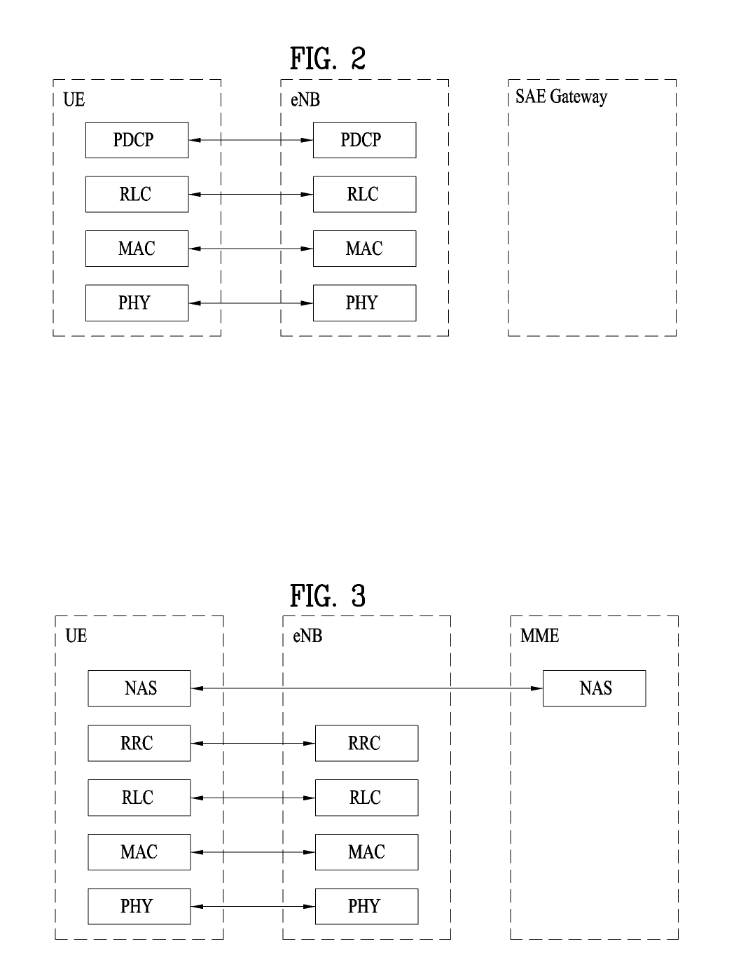

A radio interface protocol is defined in the Uu interface which is a radio section, wherein the radio interface protocol is horizontally comprised of a physical layer, a data link layer, a network layer, and vertically classified into a user plane for user data transmission and a control plane for signaling (control signal) transfer. Such a radio interface protocol can be typically classified into L1 (first layer) including a PHY layer which is a physical layer, L2 (second layer) including MAC/RLC/PDCP layers, and L3 (third layer) including an RRC layer as illustrated in FIGS. 2 and 3, based on the three lower layers of an Open System Interconnection (OSI) reference model widely known in the field of communication systems. Those layers exist as a pair in the UE and E-UTRAN, thereby performing data transmission of the Uu interface.

FIGS. 2 and 3 illustrate layers of a radio protocol. FIG. 2 illustrates a control plane and FIG. 3 illustrates a user plane.

The physical layer (PHY) which is a first layer provides information transfer services to the upper layers using a physical channel. The PHY layer is connected to the upper MAC layer through a transport channel, and data between the MAC layer and the PHY layer is transferred through the transport channel. At this time, the transport channel is roughly divided into a dedicated transport channel and a common transport channel based on whether or not the channel is shared. Furthermore, data is transferred between different PHY layers, i.e., between PHY layers at transmitter and receiver sides.

Various layers exist in the second layer. First, the MAC layer serves to map various logical channels to various transport channels, and also performs logical channel multiplexing for mapping several logical channels to one transport channel. The MAC layer is connected to an upper RLC layer through a logical channel, and the logical channel is roughly divided into a control channel for transmitting control plane information and a traffic channel for transmitting user plane information according to the type of information to be transmitted.

The RLC layer of the second layer manages segmentation and concatenation of data received from an upper layer to appropriately adjusts a data size such that a lower layer can send data to a radio section. Also, the RLC layer provides three operation modes such as a Transparent Mode (TM), an Un-acknowledged Mode (UM), and an Acknowledged Mode (AM) so as to guarantee various Quality of Services (QoS) required by each Radio Bearer (RB). In particular, AM RLC performs a retransmission function through an ARQ function for reliable data transmission.

A Packet Data Convergence Protocol (PDCP) layer of the second layer performs a header compression function for reducing the size of an IP packet header, which is relatively large in size and contains unnecessary control information to efficiently transmit IP packets, such as IPv4 or IPv6 packets, over a radio section with a relatively small bandwidth. Due to this, information only required from the header portion of data is transmitted, thereby serving to increase the transmission efficiency of the radio section. In addition, in the LTE system, the PDCP layer performs a security function, which includes ciphering for preventing the third person's data wiretapping and integrity protection for preventing the third person's data manipulation.

A radio resource control (RRC) layer located at the uppermost portion of the third layer is only defined in the control plane. The RRC layer performs a role of controlling logical channels, transport channels, and physical channels in relation to configuration, re-configuration, and release of RBs. Here, the RB denotes a logical path provided by the first and the second layers for transferring data between the UE and the UTRAN. In general, the configuration of the RB refers to a process of stipulating the characteristics of protocol layers and channels required for providing a specific service, and setting each of the detailed parameter and operation methods thereof. The RB is divided into a Signaling RB (SRB) and a Data RB (DRB), wherein the SRB is used as a path for transmitting RRC messages in the control plane while the DRB is used as a path for transmitting user data in the user plane.

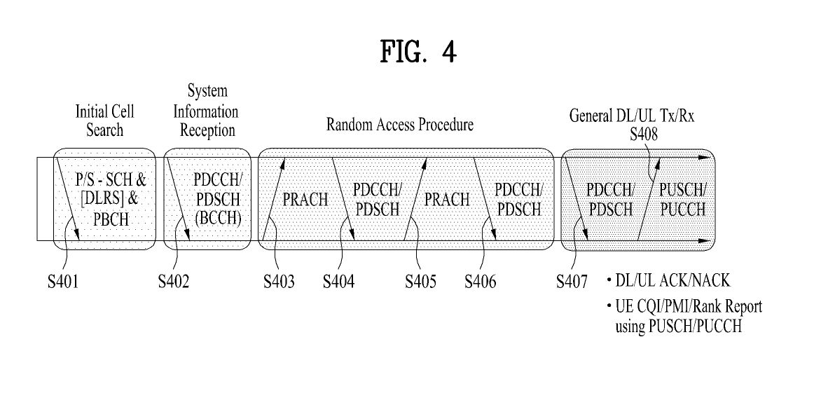

FIG. 4 illustrates physical channels and a general method for transmitting signals on the physical channels in the LTE(-A) system.

When a UE is powered on or enters a new cell, the UE performs initial cell search in step S401. The initial cell search involves acquisition of synchronization to an eNB. To this end, the UE synchronizes its timing to the eNB and acquires information such as a cell identifier (ID) by receiving a primary synchronization channel (P-SCH) and a secondary synchronization channel (S-SCH) from the eNB. Then the UE may acquire broadcast information in the cell by receiving a physical broadcast channel (PBCH) from the eNB. During the initial cell search, the UE may monitor a DL channel state by receiving a downlink reference signal (DL RS).

After the initial cell search, the UE may acquire more detailed system information by receiving a physical downlink control channel (PDCCH) and receiving a physical downlink shared channel (PDSCH) based on information of the PDCCH in step S402.

To complete access to the eNB, the UE may perform a random access procedure such as steps S403 to S406 with the eNB. To this end, the UE may transmit a preamble on a physical random access channel (PRACH) (S403) and may receive a response message to the preamble on a PDCCH and a PDSCH associated with the PDCCH (S404). In the case of a contention-based random access, the UE may additionally perform a contention resolution procedure including transmission of an additional PRACH (S405) and reception of a PDCCH signal and a PDSCH signal corresponding to the PDCCH signal (S406).

After the above procedure, the UE may receive a PDCCH and/or a PDSCH from the eNB (S407) and transmit a physical uplink shared channel (PUSCH) and/or a physical uplink control channel (PUCCH) to the eNB (S408), in a general UL/DL signal transmission procedure. Information that the UE transmits to the eNB is called Uplink Control Information (UCI). The UCI includes hybrid automatic repeat and request acknowledgement/negative acknowledgement (HARQ-ACK/NACK), scheduling request (SR), channel state information (CSI), etc. The CSI includes channel quality indicator (CQI), precoding matrix indicator (PMI), rank indication (RI), etc. UCI is generally transmitted on a PUCCH periodically. However, if control information and traffic data should be transmitted simultaneously, they may be transmitted on a PUSCH. In addition, the UCI may be transmitted aperiodically on the PUSCH, upon receipt of a request/command from a network.

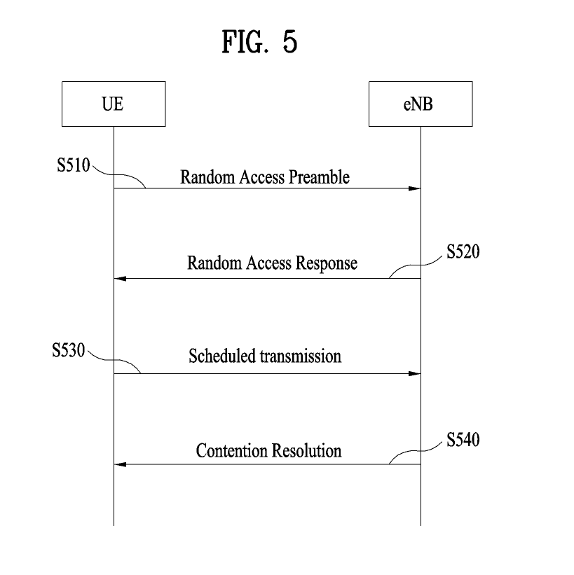

FIG. 5 illustrates a random access procedure.

The random access procedure is used to transmit short-length data in uplink. For example, the random access procedure is performed upon initial access in an RRC_IDLE mode, upon initial access after radio link failure, upon handover requiring the random access procedure, and upon the occurrence of uplink/downlink data requiring the random access procedure during an RRC_CONNECTED mode. Some RRC messages such as an RRC connection request message, a cell update message, and a URA update message are transmitted using a random access procedure. Logical channels such as a Common Control Channel (CCCH), a Dedicated Control Channel (DCCH), or a Dedicated Traffic Channel (DTCH) can be mapped to a transport channel (RACH). The transport channel (RACH) can be mapped to a physical channel (e.g., Physical Random Access Channel (PRACH)). When a UE MAC layer instructs a UE physical layer to transmit a PRACH, the UE physical layer first selects an access slot and a signature and transmits a PRACH preamble in uplink. The random access procedure is divided into a contention-based procedure and a non-contention-based procedure.

With reference to FIG. 5, a UE receives and stores information regarding random access from an eNB through system information. Thereafter, when random access is needed, the UE transmits a random access preamble (referred to as Message 1) to the eNB (S510). Upon receiving the random access preamble from the UE, the eNB transmits a random access response message (referred to as Message 2) to the UE (S520). Specifically, downlink scheduling information for the random access response message can be CRC-masked with a Random Access-RNTI and can be transmitted through an L1/L2 control channel (PDCCH). Upon receiving the downlink scheduling signal masked with the RA-RNTI, the UE can receive and decode a random access response message from a Physical Downlink Shared Channel (PDSCH). Thereafter, the UE checks whether or not random access response information corresponding to the UE is present in the received random access response message. Whether or not random access response information corresponding to the UE is present can be determined based on whether or not a Random Access preamble ID (RAID) for the preamble that the UE has transmitted is present. The random access response information includes Timing Advance (TA) indicating timing offset information for synchronization, information of allocation of radio resources used in uplink, and a temporary identity (e.g., T-CRNTI) for user identification. Upon receiving the random access response information, the UE transmits an uplink message (referred to as Message 3) through an uplink Shared Channel (SCH) according to radio resource allocation information included in the response information (S530). After receiving the uplink message from the UE, the eNB transmits a contention resolution message (referred to as Message 4) to the UE (S540).

In case of a non-contention based procedure, a base station may allocate a non-contention random access preamble to a UE before the UE transmits a random access preamble (S510). The non-contention random access preamble may be allocated through a dedicated signaling such as a handover command or PDCCH. In case that a UE is allocated with a non-contention random access preamble, the UE may transmit the allocated non-contention random access preamble to a base station in a similar manner as S510. If the base station receives the non-contention random access preamble from the UE, the base station may transmit a random access response (referred to as Message 2) to the UE.

During the above-described random access procedure, HARQ may not be applied to a random access response (S520), but HARQ may be applied to an uplink transmission for the random access response or a message for contention resolution. Thus, the UE does not have to transmit ACK/NACK in response the random access response.

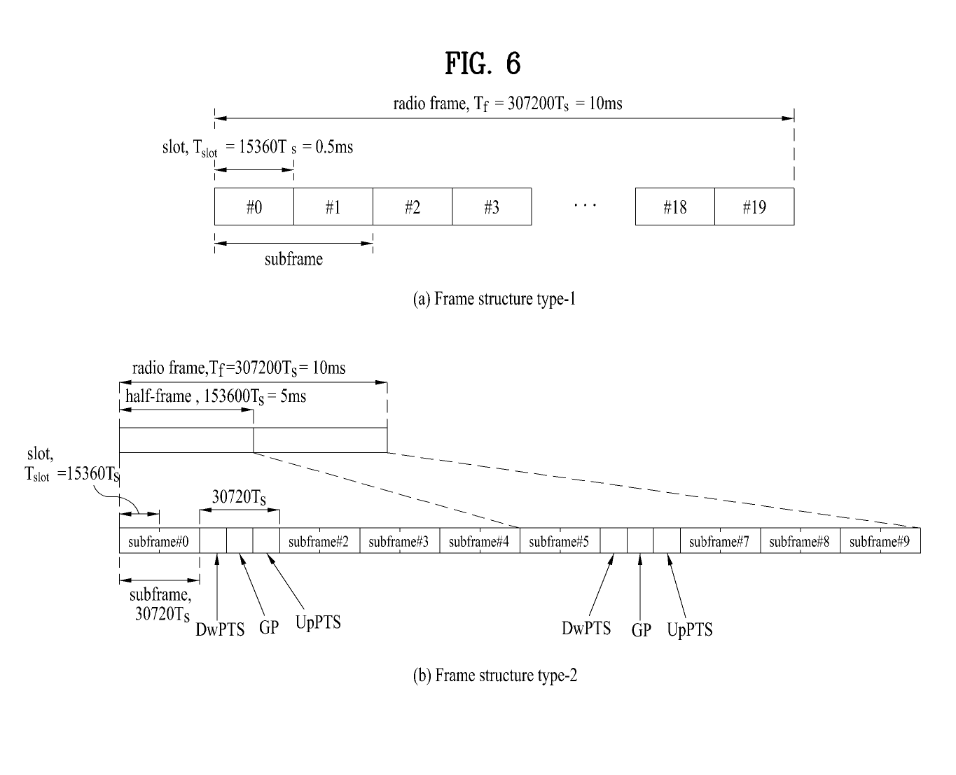

FIG. 6 illustrates a structure of a radio frame used in an LTE(-A) system. In a cellular OFDM radio packet communication system, uplink/downlink data packet transmission is performed in subframe units and one subframe is defined as a predetermined duration including a plurality of OFDM symbols. The LTE(-A) standard supports a type-1 radio frame structure applicable to frequency division duplex (FDD) and a type-2 radio frame structure applicable to time division duplex (TDD).

FIG. 6(a) shows the structure of the type-1 radio frame. A downlink radio frame includes 10 subframes and one subframe includes two slots in a time domain. A time required to transmit one subframe is referred to as a transmission time interval (TTI). For example, one subframe has a length of 1 ms and one slot has a length of 0.5 ms. One slot includes a plurality of OFDM symbols in a time domain and includes a plurality of resource blocks (RBs) in a frequency domain. In the LTE(-A) system, since OFDMA is used in downlink, an OFDM symbol indicates one symbol period. The OFDM symbol may be referred to as an SC-FDMA symbol or symbol period. An RB as a resource assignment unit may include a plurality of consecutive subcarriers in one slot.

The number of OFDM symbols included in one slot may be changed according to the configuration of a cyclic prefix (CP). The CP includes an extended CP and a normal CP. For example, if OFDM symbols are configured by the normal CP, the number of OFDM symbols included in one slot may be 7. If OFDM symbols are configured by the extended CP, since the length of one OFDM symbol is increased, the number of OFDM symbols included in one slot is less than the number of OFDM symbols in case of the normal CP. In case of the extended CP, for example, the number of OFDM symbols included in one slot may be 6. In the case where a channel state is unstable, such as the case where a UE moves at a high speed, the extended CP may be used in order to further reduce inter-symbol interference.

In case of using the normal CP, since one slot includes seven OFDM symbols, one subframe includes 14 OFDM symbols. At this time, a maximum of first two or three OFDM symbols of each subframe may be assigned to a physical downlink control channel (PDCCH) and the remaining OFDM symbols may be assigned to a physical downlink shared channel (PDSCH).

FIG. 6(b) shows the structure of the type-2 radio frame. The type-2 radio frame includes two half frames and each half frame includes five subframes, a downlink pilot time slot (DwPTS), a guard period (GP) and an uplink pilot time slot (UpPTS). One subframe includes two slots. For example, a downlink slot (e.g., DwPTS) is used for initial cell search, synchronization or channel estimation of a UE. For example, an uplink slot (e.g., UpPTS) is used for channel estimation of a BS and uplink transmission synchronization of a UE. For example, the uplink slot (e.g., UpPTS) may be used to transmit a sounding reference signal (SRS) for channel estimation in an eNB and to transmit a physical random access channel (PRACH) that carriers a random access preamble for uplink transmission synchronization. The GP is used to eliminate interference generated in uplink due to multi-path delay of a downlink signal between uplink and downlink. Table 1 below shows an uplink (UL)-downlink (DL) configuration in subframes in a radio frame in a TDD mode.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1 above, D represents a DL subframe, U represents a UL subframe, and S represents a special subframe. The special subframe includes a downlink pilot timeslot (DwPTS), a guard period (GP), and an uplink pilot timeslot (UpPTS). Table 2 below shows a special subframe configuration.

TABLE 2

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The above-described radio frame structure is purely exemplary and thus the number of subframes in a radio frame, the number of slots in a subframe, or the number of symbols in a slot may vary in different ways.

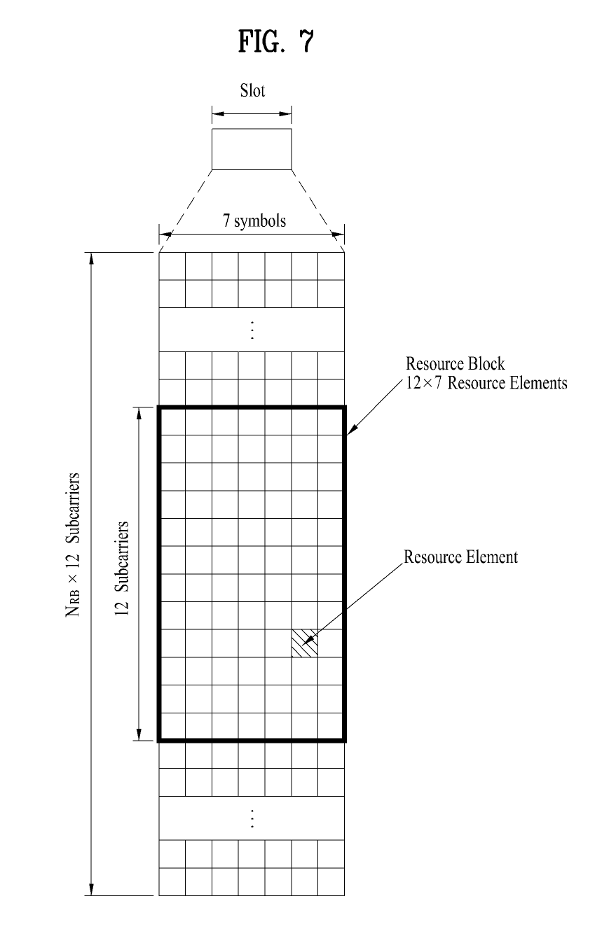

FIG. 7 illustrates a resource grid of one DL slot used in an LTE(-A) system.

Referring to FIG. 7, a DL slot includes a plurality of OFDM symbols in the time domain. One DL slot may include 7 OFDM symbols and a resource block (RB) may include 12 subcarriers in the frequency domain. However, the present invention is not limited thereto. Each element of the resource grid is referred to as a Resource Element (RE). An RB includes 12×7 REs. The number of RBs in a DL slot, N^{DL} depends on a DL transmission bandwidth. A UL slot may have the same structure as a DL slot.

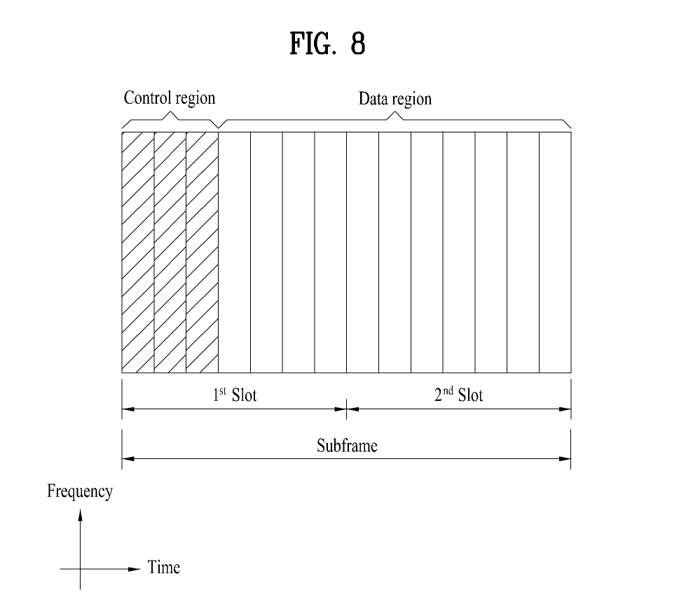

FIG. 8 illustrates a downlink subframe structure used in the LTE(-A) system.

Referring to FIG. 8, a maximum of three (four) OFDM symbols located in a front portion of a first slot within a subframe correspond to a control region to which a control channel is allocated. The remaining OFDM symbols correspond to a data region to which a physical downlink shared chancel (PDSCH) is allocated. A basic resource unit of the data region is RB. Examples of downlink control channels used in the LTE(-A) system include a physical control format indicator channel (PCFICH), a physical downlink control channel (PDCCH), a physical hybrid ARQ indicator channel (PHICH), etc.

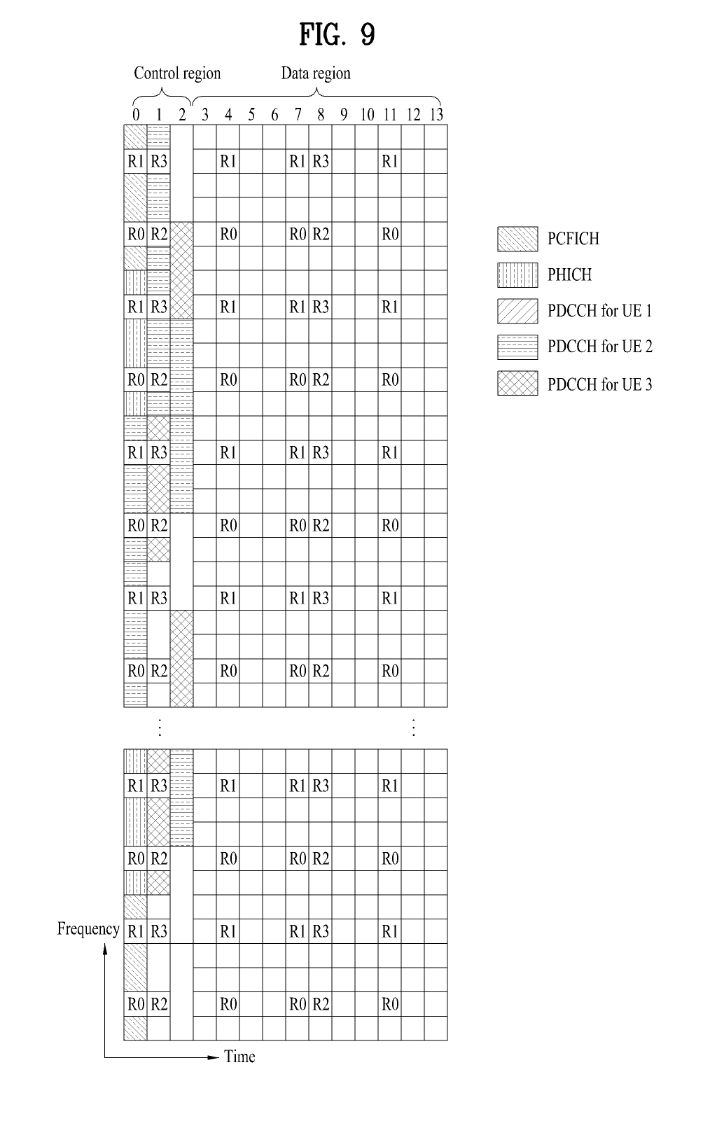

FIG. 9 illustrates a control channel allocated to a downlink subframe. In FIG. 9, R1 to R4 denote a cell-specific reference signal (CRS) or a cell-common reference signal for antenna ports 0 to 3. The CRS is transmitted in all bands every subframe and fixed in a predetermined pattern in a subframe. The CRS is used to channel measurement and downlink signal demodulation.

Referring to FIG. 9, the PCFICH is transmitted at a first OFDM symbol of a subframe and carries information regarding the number of OFDM symbols used for transmission of control channels within the subframe. The PCFICH is composed of four REGs that are uniformly distributed in a control region based on a cell ID. The PCFICH indicates a value of 1 to 3 (or 2 to 4) and is modulated via quadrature phase shift keying (QPSK). The PHICH is a response of uplink transmission and carries an HARQ acknowledgment (ACK)/negative-acknowledgment (NACK) signal. The PHICH except for CRS and PCFICH (a first OFDM symbol) is allocated on the remaining REGs in one or more OFDM symbols configured by PHICH duration. The PHICH is allocated to three REGs that are distributed if possible on the frequency domain.

The PDCCH is allocated in first n OFDM symbols (hereinafter, a control region) of a subframe. Here, n is an integer equal to or greater than 1 and is indicated by the PCFICH. Control information transmitted through the PDCCH is referred to as downlink control information (DCI). DCI format is defined as formats 0, 3, 3A, and 4 for uplink and defined as formats 1, 1A, 1B, 1C, 1D, 2, 2A, 2B, 2C, and 2D for downlink. DCI format optionally includes information about hopping flag, RB allocation, modulation coding scheme (MCS), redundancy version (RV), new data indicator (NDI), transmit power control (TPC), cyclic shift demodulation reference signal (DM-RS), channel quality information (CQI) request, HARQ process number, transmitted precoding matrix indicator (TPMI), precoding matrix indicator (PMI) confirmation, etc. according to its usage.

A PDCCH may carry a transport format and a resource allocation of a downlink shared channel (DL-SCH), resource allocation information of an uplink shared channel (UL-SCH), paging information on a paging channel (PCH), system information on the DL-SCH, information on resource allocation of an upper-layer control message such as a random access response transmitted on the PDSCH, a set of Tx power control commands on individual UEs within an arbitrary UE group, a Tx power control command, information on activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). A format of the PDCCH and the number of bits of the available PDCCH are determined by the number of CCEs. The BS determines a PDCCH format according to DCI to be transmitted to the UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging identifier (e.g., paging-RNTI (P-RNTI)) may be masked to the CRC. If the PDCCH is for system information (more specifically, a system information block (SIB)), a system information RNTI (SI-RNTI) may be masked to the CRC. When the PDCCH is for a random access response, a random access-RNTI (RA-RNTI) may be masked to the CRC.

A plurality of PDCCHs may be transmitted in one subframe. Each PDCCH is transmitted using one or more control channel elements (CCEs) and each CCE corresponds to nine sets of four resource elements. The four resource elements are referred to as a resource element group (REG). Four QPSK symbols are mapped to one REG. A resource element allocated to a reference signal is not included in an REG and thus a total number of REGs in a given OFDM symbol varies according to whether a cell-specific reference signal is present.

Table 3 shows the number of CCEs, the number of REGs, and the number of PDCCH bits according to PDCCH format.

TABLE 3

| | | | Number of |
|---|---|---|---|
| PDCCH format | Number of CCE (n) | Number of REG | PDCCH bits |
| 0 | 1 | 9 | 72 |
| 1 | 2 | 18 | 144 |
| 2 | 4 | 36 | 288 |
| 3 | 8 | 72 | 576 |

CCEs are sequentially numbered. To simplify a decoding process, transmission of a PDCCH having a format including n CCEs can be started using as many CCEs as a multiple of n. The number of CCEs used to transmit a specific PDCCH is determined by a BS according to channel condition. For example, if a PDCCH is for a UE having a high-quality downlink channel (e.g. a channel close to the BS), only one CCE can be used for PDCCH transmission. However, for a UE having a poor channel (e.g. a channel close to a cell edge), 8 CCEs can be used for PDCCH transmission in order to obtain sufficient robustness. In addition, a power level of the PDCCH can be controlled according to channel condition.

The LTE(-A) system defines a limited set of CCE positions in which a PDCCH is to be positioned for each UE. A limited set of CCE positions that a UE can find a PDCCH of the UE may be referred to as a search space (SS). In the LTE(-A) system, the SS has different sizes according to each PDCCH format. In addition, a UE-specific SS and a common SS are separately defined. The BS does not provide the UE with information indicating where the PDCCH is located in the control region. Accordingly, the UE monitors a set of PDCCH candidates within the subframe and finds its own PDCCH. The term “monitoring” means that the UE attempts to decode the received PDCCHs according to respective DCI formats. The monitoring for a PDCCH in an SS is referred to as blind decoding (blind detection). Through blind decoding, the UE simultaneously performs identification of the PDCCH transmitted to the UE and decoding of the control information transmitted through the corresponding PDCCH. For example, in the case where the PDCCH is demarked using the C-RNTI, the UE detects its own PDCCH if a CRC error is not detected. The USS is separately configured for each UE and a scope of CSSs is known to all UEs. The USS and the CSS may be overlapped with each other. When a significantly small SS is present, if some CCE positions are allocated in an SS for a specific UE, the remaining CCEs are not present. Thus a BS may not find CCE resources in which the PDCCH is to be transmitted to all available UEs in a given subframe. In order to minimize the possibility that such blocking is subsequent to a next subframe, a start position of the USS is UE-specifically hopped.

Table 4 shows sizes of CSS and USS.

TABLE 4

| | Number of CCE | Number of | Number of |
|---|---|---|---|
| PDCCH format | (n) | candidates in CSS | candidates in USS |
| 0 | 1 | — | 6 |
| 1 | 2 | — | 6 |
| 2 | 4 | 4 | 2 |
| 3 | 8 | 2 | 2 |

FIG. 10 illustrates a structure of a UL subframe in the LTE(-A) system.

Referring to FIG. 10, a UL subframe includes a plurality of (e.g. 2) slots. A slot may include a different number of SC-FDMA symbols according to a CP length. The UL subframe is divided into a control region and a data region in the frequency domain. The data region includes a PUSCH to transmit a data signal such as voice and the control region includes a PUCCH to transmit UCI. The PUCCH occupies a pair of RBs at both ends of the data region on a frequency axis and the RB pair frequency-hops over a slot boundary.

The PUCCH may deliver the following control information.
Scheduling request (SR): information requesting UL-SCH resources. An SR is transmitted in On-Off Keying (OOK).
HARQ ACK/NACK: a response signal to a DL data packet received on a PDSCH, indicating whether the DL data packet has been received successfully. A 1-bit ACK/NACK is transmitted as a response to a single DL codeword and a 2-bit ACK/NACK is transmitted as a response to two DL codewords.
CSI (Channel Status Information): feedback information regarding a DL channel. CSI includes a CQI and Multiple Input Multiple Output (MIMO)-related feedback information includes an RI, a PMI, a Precoding Type Indicator (PTI), etc. The CSI occupies 20 bits per subframe.

Table 5 below illustrates a mapping relationship between PUCCH formats and UCI in the LTE system.

TABLE 5

| PUCCH format | Uplink Control Information, UCI |
|---|---|
| Format 1 | SR (Scheduling Request) (un-modulated waveform) |
| Format 1a | 1-bit HARQ ACK/NACK (with/without SR) |
| Format 1b | 2-bit HARQ ACK/NACK (with/without SR) |
| Format 2 | CSI (20 coded bits) |
| Format 2 | CSI and 1/2-bit HARQ ACK/NACK (20 bits) |
| | (Extended CP only) |
| Format 2a | CSI and 1-bit HARQ ACK/NACK (20 + 1 coded bits) |
| Format 2b | CSI and 2-bit HARQ ACK/NACK (20 + 2 coded bits) |
| Format 3 | HARQ ACK/NACK + SR (48 bits) |
| (LTE-A) | |

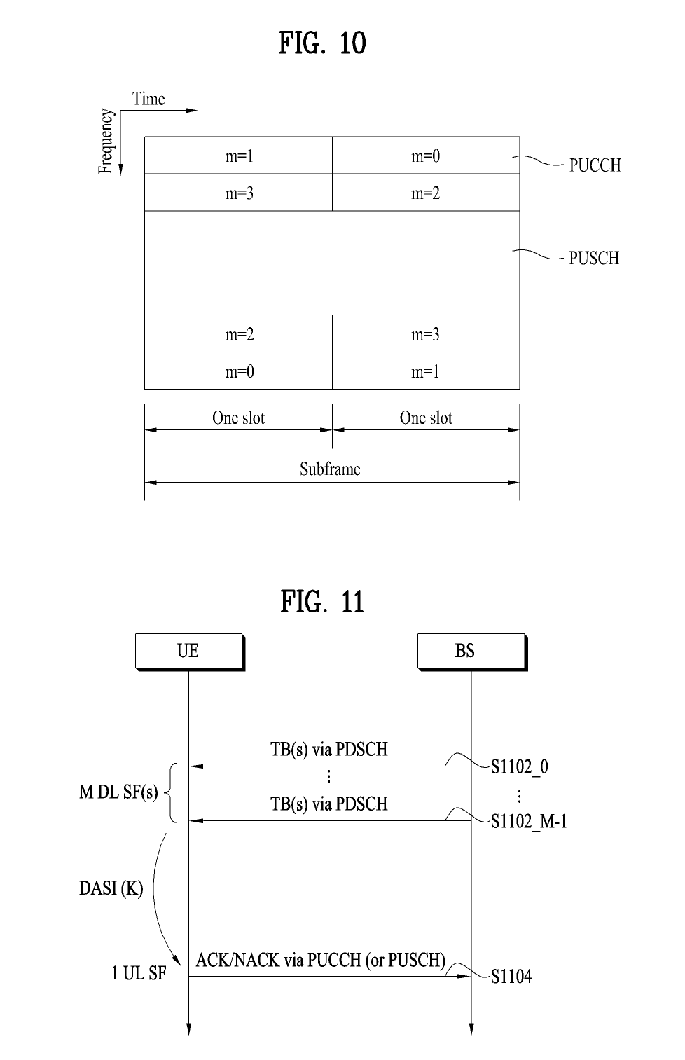

FIG. 11 is a diagram illustrating a transmitting procedure of TDD UL ACK/NACK in a single cell situation.

Referring to FIG. 11, a UE may receive one or more DL transmissions (e.g., PDSCH signal) on MDL subframes (SFs) (S1102_0 to S1102_M−1). Each PDSCH signal I used to transmit one or more (e.g., 2) transport blocks (TBs) (or a codeword (CW)) according to a transmission mode. Although not illustrated in FIG. 11, in steps S1102_0 to S1102_M−1, a PDCCH signal that requires an ACK/NACK response, for example, a PDCCH signal (simply, SPS release PDCCH signal) indicating SPS release may also be received. When a PDSCH signal and/or an SPS release PDCCH signal are present in M DL subframes, the UE transmits ACK/NACK through one UL subframe corresponding M DL subframes via a procedure (e.g., ACK/NACK (payload) generation, ACK/NACK resource allocation, etc.) for transmitting ACK/NACK (S1104). ACK/NACK includes reception response information for a PDSCH signal and/or an SPS release PDCCH signal of steps S1102_0 to S1102_M−1. Although ACK/NACK can be basically transmitted through a PUCCH, when PUSCH is transmitted at a point of time of ACK/NACK transmission, the ACK/NACK may be transmitted through a PUSCH. Various PUCCH formats of Table 3 may be used for ACK/NACK transmission. In addition, in order to reduce the number of transmitted ACK/NACK bits, various methods such as ACK/NACK bundling, ACK/NACK channel selection, etc. may be used.

As described above, in TDD, ACK/NACK for data received in M DL subframes is transmitted through one UL subframe (i.e., M DL SF(s):1 UL SF), a relation thereof is given by a downlink association set index (DASI).

Table 6 below shows DASI (K:{k0,k1, . . . kM−1}) defined in LTE(-A). Table 6 shows an interval with a DL subframe associated with a UL subframe in which ACK/NACK is transmitted in terms of the UL subframe. In detail, when PDSCH transmission and/or SPS release PDCCH are present in a subframe n−k (kεK), a UE transmits ACK/NACK corresponding to a subframe n.

TABLE 6

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

During an operation using a TDD method, a UE needs to transmit an ACK/NACK signal for one or more DL transmissions (e.g., PDSCH) received through M DL SFs through one UL SF. ACK/NACK for a plurality of DL SFs is transmitted through one UL SF using the following method.

1) ACK/NACK bundling: ACK/NACK bits for a plurality of data units (e.g., PDSCH, SPS release PDCCH, etc.) are combined via logical operation (e.g., logical-AND operation). For example, when all data units are successfully decoded, a receiver (e.g., UE) transmits an ACK signal. On the other hand, when decoding (or detecting) of even one data unit fails, the receiver may or may not transmit a NACK signal.

2) Channel selection: A UE that receives a plurality of data units (e.g., PDSCH, SPS release PDCCH, etc.) occupies a plurality of PUCCH resources for ACK/NACK transmission. An ACK/NACK response for a plurality of data units is identified by a combination of a PUCCH resource used for actual ACK/NACK transmission and transmitted ACK/NACK content (e.g., a bit value and a QPSK symbol value). The channel selection method may also be referred to as an ACK/NACK selection method or a PUCCH selection method.

In TDD, upon transmitting an ACK/NACK signal to an eNB, a UE may miss some of PDCCH(s) transmitted by the eNB for a plurality of subframe periods. In this case, the UE cannot know that a PDSCH corresponding to the missed PDCCH is transmitted to the UE, and thus errors may occur during ACK/NACK generation.

To overcome these errors, a TDD system adds a downlink assignment index (DAI) to a PDCCH. The DAI denotes accumulated values (i.e., a counting value) of PDCCH(s) corresponding to PDSCH(s) to a current subframe in DL subframe(s) n−k (kεK) and PDCCH(s) indicating DL SPS release. For example, when three DL subframes correspond to one UL subframe, indexes are sequentially applied (i.e., sequentially counted) to a PDSCH transmitted in three DL subframe periods to carry a PDCCH for scheduling a PDSCH. The UE may recognize whether a PDCCH has been appropriately received so far from the DAI information in the PDCCH. For convenience, DAI included in PDSCH-scheduling PDCCH and SPS release PDCCH is referred to as DL DAI or DAI-counter (DAI-c) or is simply referred to as DAI.

Table 7 below shows a value V^{DL}_{DAI} indicated by a DL DAI field. In this specification, DL DAI may be simply denoted by V. MSB indicates a most significant bit and LSB indicates a least significant bit.

TABLE 7

| | | Number of subframes with PDSCH |
|---|---|---|
| DAI | | transmission and with PDCCH |
| MSB, LSB | V_{DAI}^{DL} | indicating DL SPS release |
| 0, 0 | 1 | 1 or 5 or 9 |
| 0, 1 | 2 | 2 or 6 |
| 1, 0 | 3 | 3 or 7 |
| 1, 1 | 4 | 0 or 4 or 8 |

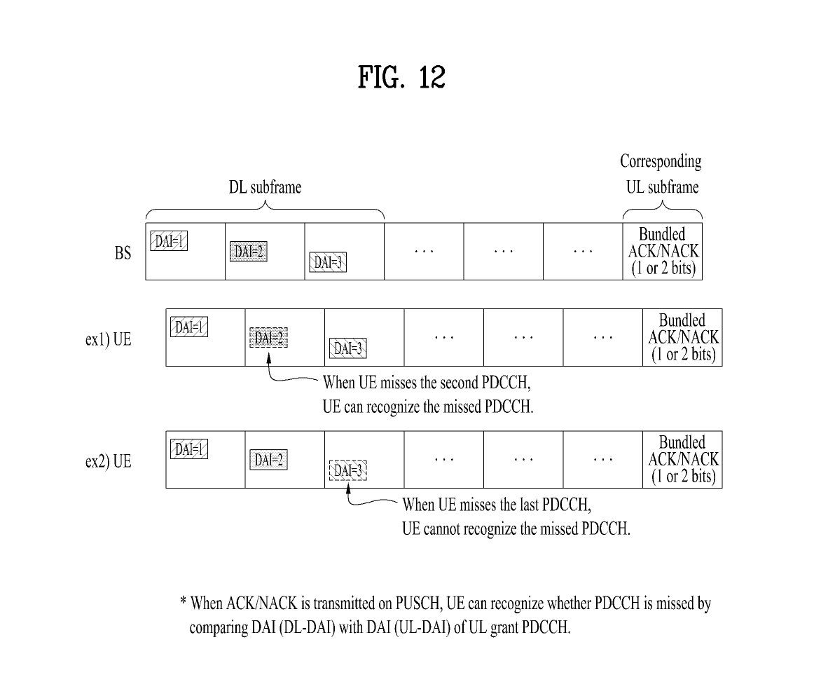

FIG. 12 illustrates an example of ACK/NACK transmission using DL DAI. This example assumes a TDD system configured with three DL subframes: one UL subframe. For convenience, it is assumed that a UE transmits ACK/NACK using a PUSCH resource. In the legacy LTE, when ACK/NACK is transmitted through a PUSCH, 1-bit or 2-bit bundled ACK/NACK is transmitted.

Referring to FIG. 12, like in the first example, when a second PDCCH is missed, a value of DL DAI of a third PDCCH is different from the number of PDCCHs that have been detected so far, and thus a UE may recognize that a second PDCCH is missed. In this case, a UE may process an ACK/NACK response for a second PDCCH as NACK (or NACK/DTX). On the other hand, like in the second example, when a last PDCCH is missed, a value of DL DAI of a lastly detected PDCCH is the same as the number of PDCCHs that have been detected so far, and thus the UE may not recognize that the last PDCCH is missed (i.e., DTX). Accordingly, the UE recognizes that only two PDCCHs are scheduled for a DL subframe period. In this case, the UE bundles only ACK/NACK corresponding to first two PDCCHs, and thus errors occur in an ACK/NACK feedback procedure. To overcome this problem, PUSCH-scheduling PDCCH (i.e., UL grant PDCCH) includes a DAI field (for convenience, a UL DAI field). The UL DAI field is a 2-bit field and the UL DAI field indicates information about the number of scheduled PDCCHs.

In detail, when V^{UL}_{DAI}≠(U_{DAI}+N_{SPS}−1)mod 4+1, the UE assumes that at least one DL allocation is lost (i.e., DTX generation) and generates NACK for all code words according to a bundling procedure. Here, U_{DAI} indicates a total number of SPS release PDCCH and DL grant PDCCHs detected in a subframe n−k (kεK) (refer to Table 6). N_{SPS} denotes the number of SPS PDSCHs and is 0 or 1.

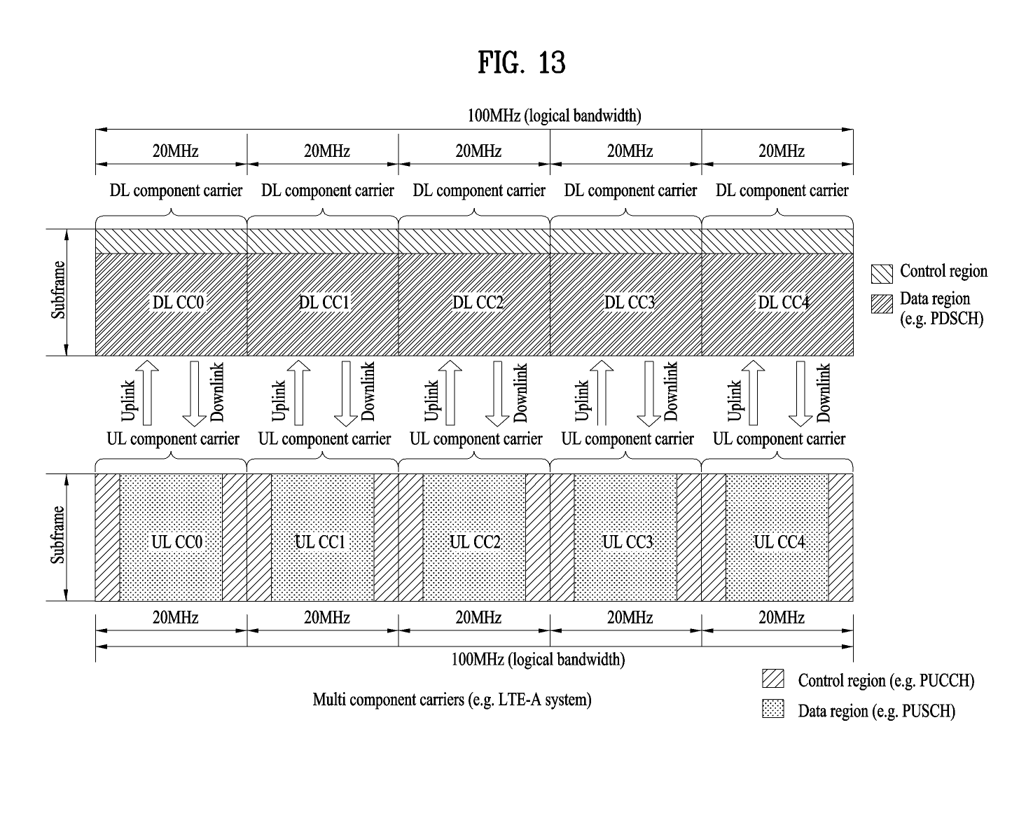

FIG. 13 illustrates a carrier aggregation (CA) communication system. An LTE-A system uses carrier aggregation or bandwidth aggregation technologies using a greater UL/DL bandwidth by collecting a plurality of UL/DL frequency blocks in order to use wider frequency band. Each frequency block is transmitted using a component carrier (CC). A CC may be understood as a carrier frequency (a center carrier or a center frequency) for a corresponding frequency block.

Referring to FIG. 13, a plurality of UL/DL CCs may be collected to support a wider UL/DL bandwidth. The CCs may or may not be adjacent to each other in the frequency domain. Bandwidths of CCs may be independently determined. Asymmetric carrier aggregation in which the number of UL CCs and the number of DL CCs are different may be possible. For example, in the case of two DL CCs and one UL CC, asymmetric carrier aggregation may be configured with 2:1. A DL CC/UL CC link may be fixed to a system and may be semi-statically configured. In addition, even if an entire band of a system is configured by N CCs, a frequency band for monitoring/receiving of a specific UE may be limited to M(<N) CCs. Various parameters for carrier aggregation may be configured cell-specifically, UE group-specifically, or UE-specifically. Control information may be configured to be transmitted and received through only a specific CC. The specific CC may be referred to as a primary CC (PCC) (or anchor CC) and the remaining CC may be referred to as a secondary CC (SCC).

The LTE(-A) system adopts the concept of cell to manage radio resources. A cell is defined as a combination of DL and UL resources, while the UL resources are optional. Accordingly, a cell may include DL resources only or both DL and UL resources. If CA is supported, the linkage between the carrier frequencies (or DL CCs) of DL resources and the carrier frequencies (or UL CCs) of UL resources may be indicated by system information. A cell operating in a primary frequency resource (or a PCC) may be referred to as a PCell and a cell operating in a secondary frequency resource (an SCC) may be referred to as an SCell. The PCell is used for a UE to establish an initial connection or to re-establish a connection. The PCell may be a cell indicated during handover. The SCell may be configured after an RRC connection is established and used to provide additional radio resources. Both a PCell and an SCell may be collectively referred to as serving cells. Accordingly, if CA has not been configured for a UE in RRC_CONNECTED state or the UE in RRC_CONNECTED state does not support CA, one serving cell including only a PCell exists for the UE. On the other hand, if CA has been configured for a UE in RRC_CONNECTED state, one or more serving cells including a PCell and one or more SCells exist for the UE. For CA, a network may add one or more SCells to a PCell initially configured during connection establishment, for a UE after initial security activation is initiated.

The LTE-A system may support aggregation of a plurality of CCs (i.e., carrier aggregation) and consider a method for transmitting ACK/NACK for a plurality of DL data (e.g., data transmitted through a PDSCH) transmitted through a plurality of CCs through only one specific CC (e.g., PCC). As described above, a CC except for a PCC may be referred to as an SCC and ACK/NACK for DL data may be referred to as “A/N”. In addition, the LTE-A system may support cross CC scheduling during carrier aggregation. In this case, one CC (e.g., scheduled CC) may be pre-configured so as to be DL/UL scheduled through one specific CC (e.g., scheduling CC) (i.e., so as to receive DL/UL grant PDCCH for corresponding scheduled CC). Cross CC scheduling (in terms of a UE) may be an appropriate operation when a control channel region of an SCC is not appropriate for PDCCH transmission due to interference influence, a channel state, etc.

If cross-carrier scheduling (or cross-CC scheduling) is used, a DL assignment PDCCH may be transmitted in DL CC #0 and a PDSCH associated with the PDCCH may be transmitted in DL CC #2. For cross-CC scheduling, a Carrier Indicator Field (CIF) may be introduced. The existence or absence of a CIF in a PDCCH may be determined semi-statically and UE-specifically (or UE group-specifically) by higher-layer signaling (e.g. RRC signaling). The baseline of PDCCH transmission is summarized as follows.
CIF disabled: a PDCCH in a DL CC allocates PDSCH resources of the same DL CC or PUSCH resources of one linked UL CC.
CIF enabled: a PDCCH in a DL CC may allocate PDSCH resources or PUSCH resources of a specific DL/UL CC from among a plurality of aggregated DL/UL CCs using a CIF.

In the presence of a CIF, an eNB may allocate a PDCCH monitoring DL CC set to a UE in order to reduce blind decoding complexity of the UE. The PDCCH monitoring CC set is a part of total aggregated DL CCs, including one or more DL CCs. The UE detects/decodes a PDCCH only in the DL CCs of the PDCCH monitoring DL CC set. The PDCCH monitoring DL CC set may be configured UE-specifically, UE group-specifically, or cell-specifically. The term “PDCCH monitoring DL CC” may be replaced with an equivalent term such as monitoring carrier, monitoring cell, etc. In addition, the term CCs aggregated for a UE may be interchangeably used with an equivalent term such as serving CCs, serving carriers, serving cells, etc.

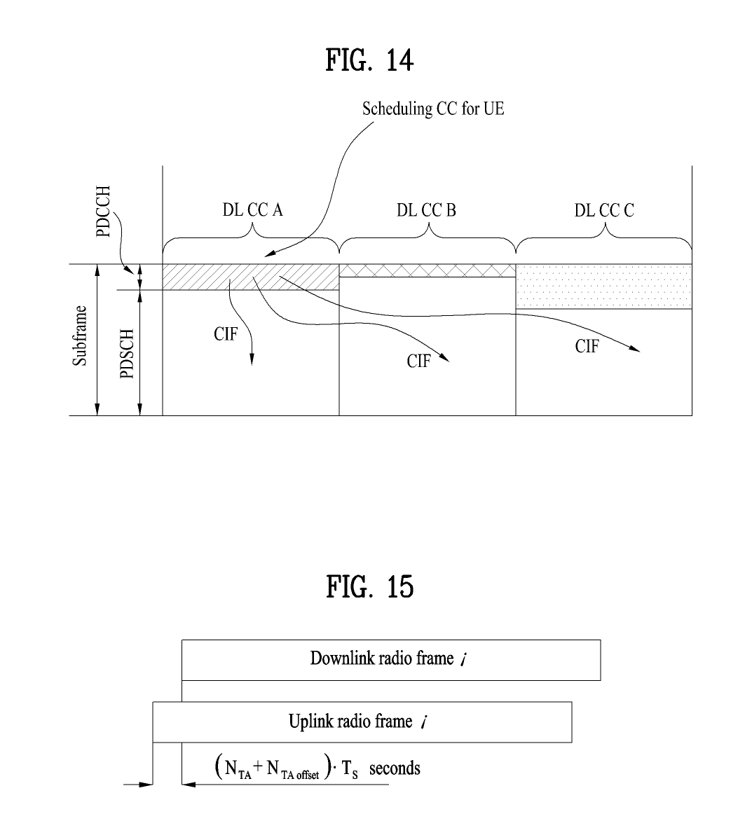

FIG. 14 illustrates an exemplary scheduling, when a plurality of carriers are aggregated. It is assumed that three DL CCs are aggregated and DL CC A is set as a PDCCH monitoring DL CC. DL CCs A, B, and C may be referred to as serving CCs, serving carriers, serving cells, etc. If a CIF is disabled, each DL CC may deliver only a PDCCH that schedules a PDSCH in the DL CC, without a CIF according to an LTE PDCCH rule. On the other hand, if a CIF is enabled by UE-specific (UE group-specific or cell-specific) higher-layer signaling, DL CC A (i.e. the monitoring CC) may deliver a PDCCH that schedules a PDSCH of another CC as well as a PDCCH that schedules a PDSCH of DL CC A, using the CIF. In this case, no PDCCH is transmitted in DL CCs B and C that are not set as PDCCH monitoring DL CCs.

The LTE-A system considers transmission of a plurality of pieces of ACK/NACK information/a plurality of ACK/NACK signals in a specific UL CC, for a plurality of PDSCHs transmitted in a plurality of DL CCs. In a multi-carrier situation of FDD LTE-A system, a plurality of ACK/NACK information/signals may be transmitted using ACK/NACK multiplexing (e.g. ACK/NACK channel selection) and PUCCH format 1a/1b which were used for the conventional LTE TDD system. Alternatively, unlike ACK/NACK transmission using PUCCH format 1a/1b in the conventional LTE, the plurality of ACK/NACK signals may be jointly encoded (e.g. using a reed-Muller code, a tail-biting convolution code, etc.) and then the jointly encoded ACK/NACK information/signal may be transmitted using a PUCCH format 3. PUCCH format 3 is a PUCCH format based on block-spreading.

PUCCH power control in LTE-A system is described hereinafter. A power for PUCCH transmitted in subframe i may be determined by Equation 1. In case that a serving cell c is a primary cell, a UE transmit power in subframe i, P_{PUCCH}(i), is given by the following equation.

$${P}_{PUCCH} ( i ) = min \{ \begin{matrix}{P}_{CMAX , c} ( i ) \\ {P}_{0 \_ PUCCH} + {PL}_{c} + h ( \cdot ) + {Δ}_{F \_ PUCCH} ( F ) + {Δ}_{TxD} ( {F}^{′} ) + g ( i )\end{matrix} \} [ dBm ] \qquad [ Equation 1 ]$$

P_{CMAX,c}(i) represents the maximum transmission power of a UE for serving cell c. P_{O}_{_{—}}_{PUCCH} is a parameter configured as a sum of P_{O}_{_{—}}_{NOMINAL}_{_{—}}_{PUCCH} and P_{O}_{_{—}}_{UD}_{_{—}}_{PUCCH} P_{O}_{_{—}}_{NOMINAL}_{_{—}}_{PUCCH} and P_{O}_{_{—}}_{UE}_{_{—}}_{PUCCH} are provided by a higher layer (e.g. RRC layer). PL_{c} represents a downlink pathloss estimate for serving cell c. A parameter Δ_{F}_{_{—}}_{PUCCH}(F) is provided by a higher layer signaling. Each value of Δ_{F}_{_{—}}_{PUCCH}(F) represents a value corresponding to a value corresponding to a corresponding PUCCH format as compared to PUCCH format 1a. If a UE is configured by a higher layer to transmit PUCCH on two antenna ports, a parameter Δ_{TxD}(F′) is provided by a higher layer. Otherwise, if PUCCH is transmitted on a single antenna port, Δ_{TxD}(F′) is 0. That is, Δ_{TxD}(F′) corresponds to a power compensation value in consideration of a transmission mode for antenna port.

h(•) is a value dependent on PUCCH format. h(•) is a function whose input parameter is at least one of n_{CQI}, n_{HARQ}, or n_{SR}. For example, in case of PUCCH format 3,

$$h ( \cdot ) = \frac{{n}_{HARQ} + {n}_{SR} - 1}{2} .$$

In this case, n_{CQI} represents a power compensation value related to channel quality information. Specifically, n_{CQI} corresponds to the number of information bits for channel quality information. n_{SR} represents a power compensation value related to SR. Specifically, n_{SR} corresponds to the number of SR bits. In case that a configured to transmit SR subframe (briefly SR subframe) corresponds to HARQ-ACK transmission timing using PUCCH format 3, a UE transmits a joint-coded SR bit (e.g. 1 bit) and one or more HARQ-ACK bits through PUCCH format 3. Thus, in an SR subframe, the size of information bits transmitted through PUCCH format 3 is always larger by one than an HARQ-ACK payload size. Thus, n_{SR} is 1 if subframe i is an SR subframe, and n_{SR} is 0 in non-SR subframe.

n_{HARQ} represents a power compensation value related to HARQ-ACK. Specifically, n_{HARQ} corresponds to the number of (valid) information bits of HARQ-ACK. Further, n_{HARQ} is defined as the number of transport blocks received in a corresponding downlink subframe. That is, power control is determined by the number of transport blocks scheduled by a base station and whose PDCCHs are successfully decoded by a UE. Meanwhile, the size of HARQ-ACK payload is determined by the number of configured DL cells. Thus, in case that a UE is configured to have one serving cell, n_{HARQ} is the number of HARQ bits transmitted in subframe i. In case that a UE has a plurality of serving cells, n_{HARQ} is given as follows. In case of TDD, in case that a UE receives SPS release PDCCH in one of subframe(s) i−kₘ (kₘεK, 0≦m≦M−1) on service cell c, n_{HARQ,c}=(the number of transport blocks received in subframe(s) i−kₘ)+1. In case that a UE does not receive SPS release PDCCH in one of subframe(s) i−kₘ (kₘεK: {k₀, k₁, . . . k_{M-1}}, 0≦m≦M−1) on serving cell c, n_{HARQ,c}=(the number of transport blocks received in subframe(s) i−kₘ). In case of FDD, n_{HARQ} is given in a similar manner as TDD, where M=1 and k0=4.

Specifically, in case of TDD,

$${n}_{HARQ} = {\sum }_{c = 0}^{C - 1} {\sum }_{{k}_{m} ∈ K} {N}_{{k}_{m} , c}^{received} ,$$

where C represents the number of configured serving cells, Nₖ_{ₘ}_{,c}^{received} represents the number of transport blocks and SPS release PDCCHs which were received in subframe(s) i−kₘ on serving cell c. In case of FDD,

$${n}_{HARQ} = {\sum }_{c = 0}^{C - 1} {N}_{c}^{received} ,$$

where N_{c}^{received} represents the number of transport blocks and SPS release PDCCHs which were received in subframe i−4 on serving cell c.

g(i) represents an adjustment state of the current PUCCH power control. Specifically,

$$g ( i ) = g ( i - 1 ) + {\sum }_{m = 0}^{M - 1} {δ}_{PUCCH} ( i - {k}_{m} ) .$$

g(o) is the first value after reset. δ_{PUCCH} is a UE-specific correction value, and is referred to as TPC command. δ_{PUCCH} is included in a PDCCH having DCI format 1A/1B/1D/1/2A/2/2B/2C in case of PCell. Further, δ_{PUCCH} is joint-coded with another UE-specific PUCCH correction value in a PDCCH having DCI format 3/3A. δ_{PUCCH} may be indicated through a TPC command field of DCI format, and may be given by Table 8 or 9.

TABLE 8

| TPC Command Field in | |
|---|---|
| DCI format | |
| 1A/1B/1D/1/2A/2B/2C/2/3 | δ_{PUCCH} [dB] |
| 0 | −1 |
| 1 | 0 |
| 2 | 1 |
| 3 | 3 |

TABLE 9

| TPC Command Field in | |
|---|---|
| DCI format 3A | δ_{PUCCH} [dB] |
| 0 | −1 |
| 1 | 1 |

FIG. 15 illustrates an example of uplink-downlink timing relation.

In the LTE system based on an orthogonal frequency division multiplex (OFDM) technology, the length of time a signal takes to reach a base station from a UE may vary according to a radius of a cell, a location of the UE in a cell, a mobility of the UE, etc. That is, unless the base station controls UL transmission timing for each UE, there is possibility of interferences between UEs during a communication between the UE and the base station, and this causes an increase of error rate in the base station. The length of time a signal takes to reach a base station from a UE may be referred to as a timing advance. Assuming that a UE may be located randomly within a cell, the timing advance from the UE to the eNB may be varied based on a location of the UE. Thus, a base station must manage or handle all data or signals transmitted by UEs within the cell in order to prevent interferences between UEs. Namely, a base station must adjust or manage a transmission timing of UEs according to each UE's circumstances, and such adjustment or management may be referred to as a maintenance of timing advance (or time alignment).

The maintenance of timing advance (or time alignment) may be performed via a random access procedure. During the random access procedure, a base station receives a random access preamble transmitted from a UE, and the base station can calculate a timing advance (Sync) value using the received random access preamble, where the timing advance value is to adjust (i.e., faster or slower) a signal transmission timing of the UE. The calculated timing advance value can be notified to the UE by a random access response, and the UE may update the signal transmission timing based on the calculated timing advance value. As an alternative, a base station may receive a sounding reference signal (SRS) transmitted from a UE periodically or randomly, the base station may calculate the timing advance (Sync) value based on the SRS, and the UE may update the signal transmission timing based on the calculated timing advance value.

As explained above, a base station may measure a timing advance of a UE via a random access preamble or SRS, and may notify an adjustment value of time alignment to the UE. Here, the value for time alignment (i.e., the adjustment value of time alignment) can be referred to as a timing advance command (TAC). The TAC may be processed by a MAC (medium access control) layer. Since a UE does not remain in a fixed location, the transmission timing is frequently changed according to the UE's location and/or mobility. Thus, if the UE receives the timing advance command (TAC) from eNB, the UE expect that the timing advance command is valid only for certain time interval. A time alignment timer (TAT) is used for indicating or representing the certain time interval. As such, the time alignment timer (TAT) is started when a UE receives a TAC (time advance command) from a base station.

With reference to FIG. 15, transmission of the uplink radio frame number i from a UE may start (N_{TA}+N_{TAoffset})×Tₛ seconds before the start of the corresponding downlink radio frame at the UE, where 0≦N_{TA}≦20512, N_{TAoffset}=0 for FDD frame structure and N_{TAoffset}=624 for TDD frame structure. When N_{TA} is indicated by a timing advance command, the UE may adjust a transmission timing of UL signals (e.g., PUCCH, PUSCH, SRS, etc.) by using (N_{TA}+N_{TAoffset})×Tₛ. UL transmission timing may be adjusted in units of a multiple of 16Tₛ. Tₛ represents a sampling time. A timing advance command (TAC) in a random access response is 11 bits and indicates a value of 0 to 1282, and N_{TA} is given as N_{TA}=TA*16. Alternatively, a timing advance command (TAC) is 6 bits and indicates a value of 0 to 63, and N_{TA} is given as N_{TA,old}+(TA−31)*16. The timing advance command received in subframe n is applied starting from subframe n+6.

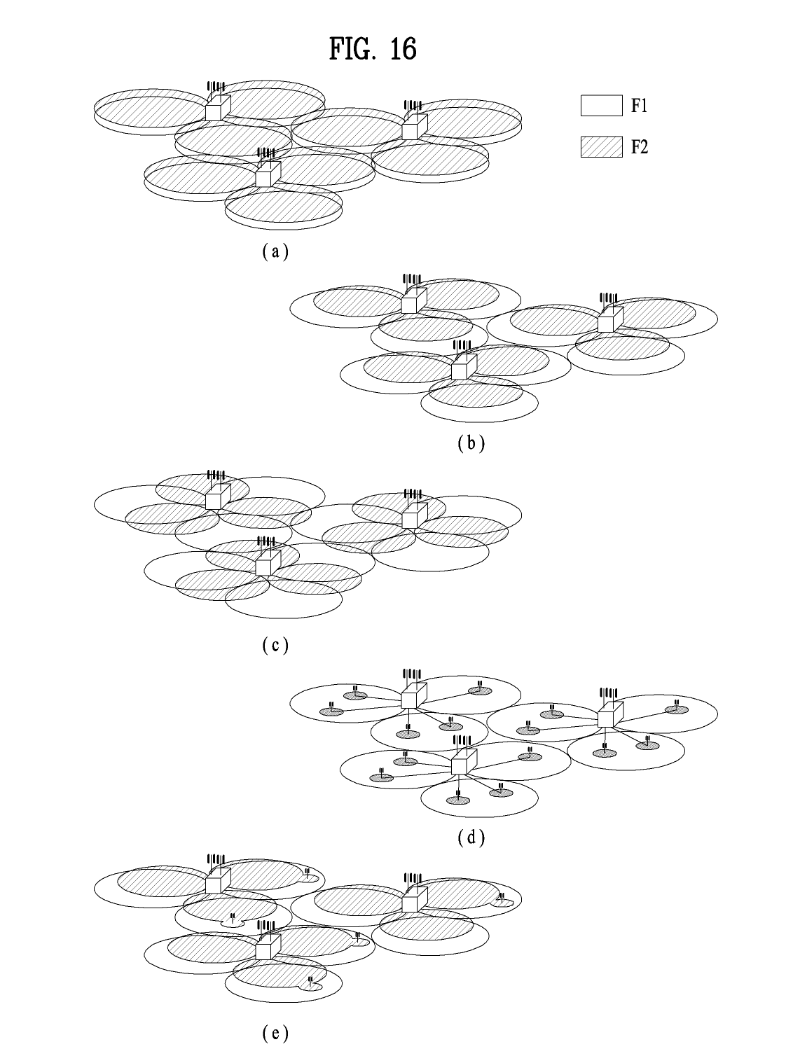

FIG. 16 illustrates examples in which 2 component carriers with different frequency characteristics are aggregated. In case that a plurality of serving cells are used in a UE, there may exist serving cells having similar timing advance characteristics. For example, serving cells using similar frequency characteristics (e.g. frequency bands) may have similar timing advance characteristics. Thus, when carrier aggregation (CA) is configured, serving cells having similar timing advance characteristics may be managed as a group to optimize signaling overhead due to adjustment of a plurality of uplink timing synchronizations. Such a group may be referred to as timing advance group (TAG). Serving cell(s) having similar timing advance characteristics may belong to one TAG, and at least one serving cell(s) must have an uplink resource in the TAG. For each serving cell, a base station may inform a UE of TAG allocation using a TAG identifier through a higher layer signaling (e.g. RRC signaling). Two or more TAGs may be configured for one UE. If a TAG identifier indicates 0, this may imply a TAG including a PCell. For convenience, a TAG including a PCell may be referred to as a primary TAG (pTAG), and TAG(s) other than a pTAG may be referred to as a secondary TAG (sTAG or secTAG). A secondary TAG identifier (sTAG ID) may be used to indicate sTAG corresponding to an SCell. If an sTAG ID is not configured for an SCell, the SCell may be configured as a part of pTAG.

With reference to FIG. 16, cells (e.g. F1 and F2) may have various locations or coverages, and thus may have different frequency characteristics. For example, in FIG. 16(b), cells (e.g. F1 and F2) may have different frequency characteristics and different coverages because the cells are co-located but have different frequency bands (e.g. F1 is 800 MHz, F2 is 3.5 GHz). In another example, in FIG. 16(d), a first cell (e.g. F1) provides macro coverage and a second cell (e.g. F2) provides a limited coverage through a Remote Radio Head (RRH) (e.g. repeater), thereby the cells having different frequency characteristics. In such examples, a first cell (e.g. F1) and a second cell (e.g. F2) may have different timing advance characteristics and may be configured as different TAGs.

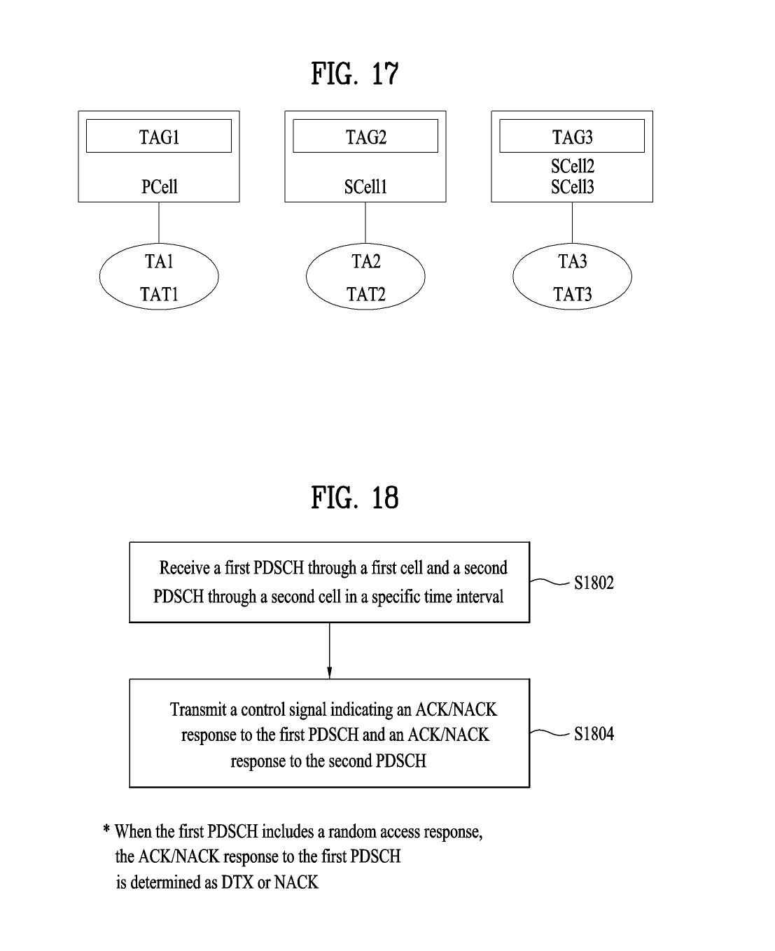

FIG. 17 illustrates an example of configuring timing advance groups for serving cells having similar timing advance characteristics.

With reference to FIG. 17, three exemplary TAGs (e.g., TAG1, TAG2, and TAG3) are configured for a UE. TAG1 may be referred to as a primary TAG (pTAG) since TAG1 contains a PCell. Each of TAG2 and TAG3 may be referred to as a secondary TAG (sTAG) since they contain SCell(s) only. TAG1, TAG2, and TAG3 may have different timing advance (or time alignment) values, e.g., TA1, TA2, and TA3, respectively. Moreover, TAG1, TAG2, and TAG3 may be configured to have different time alignment timers, e.g., TAT1, TAT2, and TAT3. The UE is allowed to start a random access procedure on serving cells which belong to sTAGs, e.g., TAG2 and TAG3, only when the UE receives a command from a base station. When TAT1 associated with pTAG has expired or is not running, the other TATs, e.g. TAT2 and TAT3, are not allowed to run. Thus, when TAT1 has expired or is not running, it is assumed that time alignments on PCell, SCell1, SCell2, and SCell3 are not correct. Meanwhile, when a TAT associated with a sTAG has expired or is not running, it is assumed that the time alignment(s) on the corresponding SCell(s) associated with sTAG are not correct. When TAT3 associated with TAG3 has expired or is not running, it is assumed that only the time alignments on SCells 2 and 3 associated with TAG3 are not correct.

As described with reference to FIGS. 5 and 15, when timing alignment for uplink transmission is not appropriate, a UE may adjust timing alignment via a random access procedure. When timing alignment is not appropriate, the UE may not permit uplink transmission due to interference with other UEs, and when timing alignment is not appropriate, the UE may not permit an ACK/NACK signal to downlink data. For example, even if the UE receives a PDSCH including a random access response (RAR) during a random access procedure for timing alignment, the UE does not transmit ACK/NACK to the PDSCH (refer to FIG. 5). Accordingly, in a single CC/cell-based LTE system, when a PDSCH corresponding to RA-RNTI and a PDSCH corresponding to C-RNTI (or SPS C-RNTI) are simultaneously allocated to the same subframe, the UE may omit a detection/decoding operation for a PDSCH (i.e., a PDSCH scheduled from a PDCCH scrambled based on C-RNTI (or SPS C-RNTI)) corresponding to C-RNTI (or SPS C-RNTI). This is because a PRACH is a signal transmitted according to an order (i.e., a PDCCH order) from an eNB or spontaneous determination of the UE when UL sync is unstable, and thus uplink transmission of ACK/NACK feedback to a general PDSCH cannot be performed during the random access procedure accompanied by the signal. Hereinafter, for convenience of description, a PDSCH carrying a random access response (RAR) corresponding to the RA-RNTI is referred to as “RAR-PDSCH”, and a PDSCH carrying general DL data corresponding to C-RNTI (or SPS C-RNTI) is referred to as “GEN-PDSCH”.

As described above, an LTE-A system may basically support carrier aggregation (CA) for a plurality of CC/cells and apply independent TA parameters to respective TAGs, each of which includes one or more CC/cells. As such, a plurality of TAGs may be configured for one UE. As described above, a TAG to which a PCell belongs may be referred to as pTAG and a TAG to which only a SCell belongs may be referred to as sTAG. In this case, a TA parameter applied to the pTAG may control timing (i.e., UL sync) for UL signal/channel transmission (e.g., PUSCH/PUCCH/SRS) in the PCell and UL signal/channel transmission (e.g., PUSCH/SRS) in the SCell to which the corresponding TAG belongs, and a TA parameter applied to the sTAG may control UL sync for UL signal/channel transmission (e.g., PUSCH/SRS) in the SCell to which the corresponding sTAG belongs.

In this case, for example, when UL sync of the pTAG is normally operated in a situation of a plurality of CC/cells and a plurality of TAGs, an eNB may order a UE to transmit a PRACH through a specific SCell belonging to the corresponding sTAG (using a PDCCH order) for readjustment of UL sync for the sTAG. In this case, since UL sync of the pTAG is normally operated, UL transmission in the PCell may be stable, distinguished from the aforementioned case. As described above, since UL control information (UCL) including ACK/NACK feedback is transmitted through only the PCell and UL syn of the pTAG including the PCell is normally operated, the UE may transmit ACK/NACK feedback for a PDSCH (through a PUCCH in the PCell or a PUSCH in the pTAG). In this case, the UE may transmit both RAR-PDSCH transmitted through a random access procedure and ACK/NACK feedback for GEN-PDSCH carrying general DL data. For example, assuming that a PDCCH scrambled with RA-RNTI and a RAR-PDSCH corresponding thereto are allocated/transmitted to the PCell, when the RA-RNTI and the C-RNTI (or SPS C-RNTI) are simultaneously allocated to the same subframe, the UE may omit a detection/decoding operation on GEN-PDSCH corresponding to C-RNTI (or SPS C-RNTI) with respect to only a PCell. In other words, when the RA-RNTI and C-RNTI (or SPS C-RNTI) are simultaneously allocated to the same subframe, the UE may (simultaneously) detect/decode a RAR-PDSCH transmitted through the PCell and/or a GEN-PDSCH transmitted through the SCell.

In the case of a current LTE-A system, a RAR-PDSCH includes parameters required for a random access (RA) procedure that basically includes timing alignment (TA), and further includes specific UL grant for confirmation of RAR-PDSCH reception and readjusted UL sync. The RAR-PDSCH reception is not accompanied by separate ACK/NACK feedback transmission, and the UE may transmit a PUSCH (i.e., message 3 or Msg3) through a resource region to which corresponding UL grant is allocated by applying a random access (RA) parameter such as a TA value transmitted through the received RAR-PDSCH. Accordingly, it is necessary to define ACK/NACK feedback configuration and transmission method when a RAR-PDSCH transmitted through the PCell and a GEN-PDSCH transmitted through the SCell, as described above.

Method 1

The present invention proposes a method of processing an ACK/NACK response corresponding to a RAR-PDSCH of a PCell or an ACK/NACK response to the PCell as DTX (or NACK) when the RAR-PDSCH transmitted through the PCell and the GEN-PDSCH transmitted through the SCell are simultaneously received.

In a TDD system configured to transmit ACK/NACK feedback for DL data received through one or DL subframes through one UL subframe, both the RAR-PDSCH transmitted from the PCell and a GEN-PDSCH transmitted from the SCell are received through the same or different DL subframes in the same bundling window. For convenience, one or more DL subframe(s) linked with one UE subframe are defined as “bundling window”. In this case, the present invention proposes a method of processing an ACK/NACK response to all DL subframes (or all DAI values) (belonging to the corresponding bundling window) of the PCell as DTX (or NACK).

According to the present invention, when a UE processes the ACK/NACK response for the RAR-PDSCH as DTX (or NACK), the UE may not apply a TPC command in a PDCCH (scrambled based on the RA-RNTI) for scheduling the corresponding RAR-PDSCH to PUCCH power control or may disregard the TPC command. In addition, when UE calculates power for PUCCH transmission, the UE does not necessarily consider an ACK/NACK response to the RAR-PDSCH (refer to Equation 1). For example, the corresponding RAR-PDSCH may be excluded from calculation of parameter n_{HARQ} for PUCCH power control.

Upon receiving both the RAR-PDSCH transmitted from the PCell through the same DL subframe or the same bundling window (in the case of TDD) and the GEN-PDSCH (transmitted from the SCell), the UE may operate while assuming that a corresponding RAR-PDSCH and a PDCCH (scrambled based on the RA-RNTI) for scheduling the RAR-PDSCH are not detected/received (from the viewpoint of ACK/NACK feedback configuration and PUCCH power control for the feedback configuration).

Only in a TDD system (in particular, considering that both the RAR-PDSCH and the GEN-PDSCH through the PCell through the same bundling window), when DAI remaining as a reserved field in a PDCCH (i.e., a PDCCH for scheduling the RAR-PDSCH) scrambled based on the RA-RNTI is enabled and used as original use, an ACK/NACK response corresponding to the DAI value included in the RA-RNTI-based PDCCH of ACK/NACK feedback corresponding to the PCell may be processed as DTX (or NACK).

In addition, an ACK/NACK response to a DL subframe, in which the RA-RNTI-based PDCCH (the RAR-PDSCH scheduled through the RA-RNTI-based PDCCH) is detected/received, of ACK/NACK feedback corresponding to the PCell may be processed as DTX (or NACK). Alternatively, an ACK/NACK response (i.e., DTX or NACK) to the RAR-PDSCH in an ACK/NACK payload corresponding to the PCell of overall ACK/NACK feedback corresponding to a bundling window may correspond to a specific ACK/NACK bit position. For example, the specific bit position may be configured as a least significant bit (LSB) or a bit corresponding to last DL DAI or configured as a second LSB or a bit corresponding to a second last DL DAI from the last DAI (in consideration of the case in which a PDSCH transmitted without a PDCCH is present).

FIG. 18 is a flowchart of a method of configuring and transmitting ACK/NACK according to the present invention.

In operation S1802, a UE may receive a first PDSCH through a first cell and receive a second PDSCH through a second cell in specific time interval. For example, the first cell may be a PCell and the second cell may be a SCell. For example, in the case of FDD system, the specific time interval may correspond to one subframe, and in the case of TDD system, the specific time interval may correspond to one or more downlink subframes (i.e., bundling window) associated with an uplink subframe (in which an ACK/NACK signal is transmitted). For example, the first PDSCH may correspond to the RAR-PDSCH and the second PDSCH may correspond to the GEN-PDSCH.

Although not illustrated, the UE may receive the first PDCCH for scheduling the PDSCH through the first cell and receive the second PDCCH for scheduling the second PDSCH through the second cell prior to operation S1802. For example, the first PDCCH may be masked (or scrambled) with an identifier (e.g., RA-RNTI) for random access and the second PDCCH may be masked (or scrambled) with an identifier (e.g., C-RNTI or SPS C-RNTI) for a specific UE.

According to the present invention, even if the first PDSCH is successfully received, when the first PDSCH includes a random access response, ACK/NACK response to the first PDSCH or an ACK/NACK response for the first cell may be determined as DTX or NACK. When the first PDSCH includes a random access response, this means that the first PDCCH for scheduling the first PDSCH is masked (or scrambled) with an identifier (e.g., RA-RNIT) for random access. In addition, in the case of TDD system, an ACK/NACK response to all PDSCHs received through downlink subframe(s) (i.e., bundling window) associated with the same uplink subframe or an ACK/NACK response for the cell may be determined as DTX or NACK. For example, in the case of TDD system, assuming that the first PDSCH and the second PDSCH are received in the first subframe and the third PDSCH is received in the second subframe through the first cell, when the first PDSCH or the third PDSCH received through the first cell includes a random access response, an ACK/NACK response to the first PDSCH and the third PDSCH may be determined as DTX or NACK.

In operation S1804, the UE may transmit a control signal indicting an ACK/NACK response to the first PDSCH and an ACK/NACK response to the second PDSCH to an eNB. For example, the control signal may be transmitted through a PUCCH. In addition, the control signal may be transmitted through methods such as ACK/NACK bundling, channel selection, PUCCH format 3, etc. as necessary.

In addition, for example, power for transmission of the control signal may be determined according to Equation 1. In this case, a power control command (e.g., a TPC command) received through the first PDCCH may be excluded from calculation of power for transmission of the control signal (i.e., the power control command may not be applied). For example, when the first PDCCH is masked (or scrambled) with an identifier (e.g., RA-RNTI) for random access, δ_{PUCCH} may be received through the first PDCCH (refer to Tables 8 and 9) and δ_{PUCCH} may be excluded from calculation of Equation 1 (i.e., δ_{PUCCH} may not be included in calculation). In addition, when the PDCCH is masked (or scrambled) with an identifier for random access (or the first PDSCH includes a random access response), the number of transport blocks received through the first PDSCH may be excluded from calculation of a bit number n_{HARQ} included in the control signal (i.e., the number of transport blocks may not be included in calculation (refer to the description of Equation 1).

In the description of FIG. 18, the PDSCH may be replaced with data or a transport block. Although two cells and two PDSCHs are exemplified for convenience of description, the present invention is not limited thereto. For example, the present invention may be applied in the same way to the case in which three or more cells are aggregated and/or three or more PDSCHs are received.

Method 2

As another method, PDCCH/PDSCH as a target of generation/transmission of an ACK/NACK response (and/or a target of extraction of a TPC command for PUCCH power control and calculation of a parameter n_{HARQ}) may be limited only to a PDCCH scrambled based on the C-RNTI (or SPS C-RNTI) and PDSCH (e.g., GEN-PDSCH) scheduled from the scrambled PDCCH. According to this method, even if both the RAR-PDSCH transmitted from the PCell and the GEN-PDSCH transmitted from the SCell through the same DL subframe or the same bundling window (in the case of TDD) are received, the UE may not detect/receive PDCCH/PDSCH corresponding to the C-RNTI (or SPS C-RNTI) through the PCell, and thus cannot detect/receive PDCCH/PDSCH corresponding to the C-RNTI (or SPS C-RNTI) through the PCell. Accordingly, an ACK/NACK response corresponding to the PCell (or all DL subframes or DAI values of the PCell) or an ACK/NACK response to the PCell may be automatically processed as DTX (or NACK) (which is equivalent to the above proposal). In addition, the RAR-PDSCH and RA-RNTI-based PDCCH for scheduling the RAR-PDSCH may also be automatically excluded from extraction of the TPC command and calculation of a parameter n_{HARQ}.

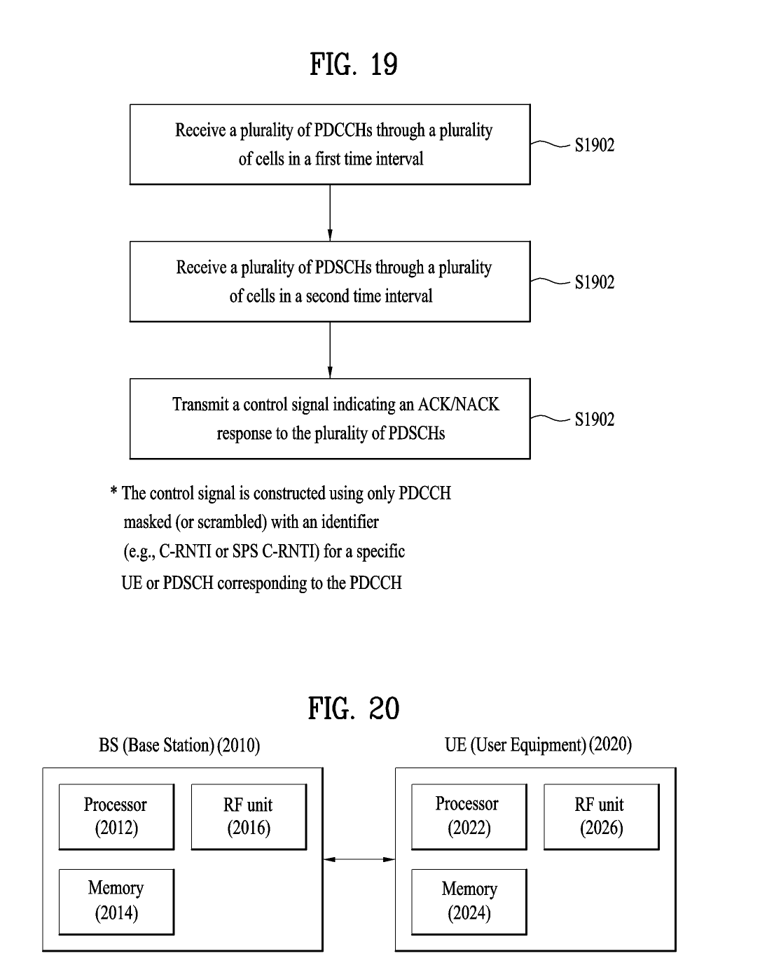

FIG. 19 is a flowchart of a method of configuring and transmitting ACK/NACK according to the present invention.

In operation S1902, a UE may receive a plurality of PDCCHs for respectively scheduling a plurality of PDSCHs through a plurality of cells in a first time interval. For example, the plurality of cells may include at least a PCell and a SCell. For example, one of the plurality of PDCCHs may be masked (or scrambled) with an identifier (e.g., RA-RNTI) for random access and another one of the plurality of PDCCHs may be masked scrambled) with an identifier (e.g., C-RNTI or SPS C-RNTI) for a specific UE.

In operation S1904, the UE may receive a plurality of PDSCHs that are respectively scheduled by the plurality of PDCCHs through a plurality of cells in a second time interval. For example, the second time interval may correspond to one subframe in in the case of an FDD system and may correspond to one or more downlink subframes (i.e., a bundling window) associated with an uplink subframe (in which an ACK/NACK signal is transmitted) in the case of a TDD system. In addition, for example, the plurality of PDSCHs may include a RAR-PDSCH and/or a GEN-PDSCH.

In addition, according to the present invention, when an ACK/NACK response for the plurality of PDSCHs is determined, only a PDCCH masked (or scrambled) with an identifier (e.g., C-RNTI or SPS C-RNTI) for a specific user and a PDSCH corresponding to the PDCCH may be considered. Accordingly, in operation S1906, a control signal indicating an ACK/NACK response may be configured to use only the PDCCH masked (or scrambled) with the identifier (e.g., C-RNTI or SPS C-RNTI) for the specific user and the PDSCH corresponding to the PDCCH as a target. Accordingly, a PDCCH masked (or scrambled) with an identifier (e.g., RA-RNTI) for random access and a PDSCH corresponding to the PDCCH may be automatically excluded.

In operation S1906, the UE may transmit a control signal indicating an ACK/NACK response to a plurality of PDSCHs to an eNB. For example, the control signal may be transmitted through a PUCCH. In addition, the control signal may be transmitted through methods such as ACK/NACK bundling, channel selection, PUCCH format 3, etc. as necessary.

In addition, for example, power for transmission of the control signal may be determined according to Equation 1. In this case, a power control command (e.g., a TPC command) received through a PDCCH masked (or scrambled) with an identifier (e.g., an RA-RNTI) for random access may be excluded from calculation of power for transmission of the control signal (i.e., the power control command may not be applied). For example, when the first PDCCH is masked (or scrambled) with an identifier for random access, δ_{PUCCH} may be received through the first PDCCH (refer to Tables 8 and 9) and δ_{PUCCH} may be excluded from calculation of Equation 1 (i.e., δ_{PUCCH} may not be included in calculation). In addition, when the first PDCCH is masked (or scrambled) with an identifier for random access (or the first PDSCH includes a random access response), the number of transport blocks received through the first PDSCH may be excluded from calculation of a bit number n_{HARQ} included in the control signal (i.e., the number of transport blocks may not be included in calculation (refer to the description of Equation 1).

In the description of FIG. 19, the PDSCH may be replaced with data or a transport block. Although two cells and two PDSCHs are exemplified for convenience of description, the present invention is not limited thereto. For example, the present invention may be applied in the same way to the case in which three or more cells are aggregated and/or three or more PDSCHs are received.

In the description of Method 1 and Method 2, although the example in which the RAR-PDSCH is received through the PCell and the GEN-PDSCH is received through the SCell has been described, the present invention is not limited to this example. In the above description, the PCell may be replaced with a specific cell to which the RA-RNTI is allocated (or configured to detect/receive the RAR-PDSCH), and the SCell may be replaced with the remaining cells except for the corresponding specific cell. For example, when the RA-RNTI is allocated to a specific cell that is not a PCell, the RAR-PDSCH is received through the specific cell, and the GEN-PDSCH is received through other cells, an ACK/NACK response to the RAR-PDSCH or an ACK/NACK response for the specific cell may also be processed as DTX or NACK.

FIG. 20 illustrates a base station and a UE to which the present invention is applicable.

Referring to FIG. 20, a wireless communication system includes a base station (BS) 2010 and a user equipment (UE) 2020. When the wireless communication system includes a relay, the BS 2010 or the UE 2020 can be replaced with the relay.

The BS 2010 includes a processor 2012, a memory 2014, and a radio frequency (RF) unit 2016. The processor 2012 may be configured to embody the procedures and/or methods proposed by the present invention. The memory 2014 is connected to the processor 2012 and stores various pieces of information associated with an operation of the processor 2012. The RF unit 2016 is connected to the processor 2012 and transmits/receives a radio signal. The UE 2020 includes a process 2022, a memory 2024, and an RF unit 2026. The processor 2022 may be configured to embody the procedures and/or methods proposed by the present invention. The memory 2024 is connected to the processor 2022 and stores various pieces of information associated with an operation of the processor 2022. The RF unit 2026 is connected to the processor 2022 and transmits/receives a radio signal.

The embodiments of the present invention may be implemented by various means, for example, hardware, firmware, software, or a combination thereof.

In a hardware implementation, an embodiment of the present invention may be implemented by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software implementation, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

A software module including instructions and/or data implementing the embodiments of the present invention may include a script, a batch, or other executable files. The software module may be stored on a machine-readable or computer-readable storage medium such as a disk drive. Storage media used for storing software modules in accordance with an embodiment of the invention may be an arbitrary type of disk including a floppy disk, an optical disk, DVD, CD-ROM, a micro drive, a magneto-optical disk, or an arbitrary ROM, RAM, EPROM, EEPROM, DRAM, VRAM, flash memory device, a magnetic or optical card, a nanosystem (including molecular memory IC), or an arbitrary type of medium suitable for storing instructions and/or data. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein.

In case that a software module implementing the embodiments of the present invention is stored in a computer-readable storage medium, the software module may be implemented as codes or instructions enabling a server or computer to execute the embodiments of the present invention when the codes or instructions are executed by a processor (e.g., microprocessor).

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

Specific operations to be conducted by the base station in the present invention may also be conducted by an upper node of the base station as necessary. In other words, it will be obvious to those skilled in the art that various operations for enabling the base station to communicate with the terminal in a network composed of several network nodes including the base station will be conducted by the base station or other network nodes other than the base station. The term “base station (BS)” may be replaced with a fixed station, Node-B, eNode-B (eNB), or an access point as necessary. The term “terminal” may also be replaced with a user equipment (UE), a mobile station (MS) or a mobile subscriber station (MSS) as necessary.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention is applicable to a wireless communication apparatus such as a user equipment (UE), a base station (BS), relay, etc.

1. A method of transmitting a signal by a user equipment (UE) in a wireless communication system in which a plurality of cells comprising a first cell and a second cell are aggregated, the method comprising:
receiving a first physical downlink shared channel (PDSCH) through the first cell and a second PDSCH through the second cell in a specific time interval; and
transmitting an control signal indicting an acknowledgement (ACK)/negative acknowledgment (NACK) response to the first PDSCH and an ACK/NACK response to the second PDSCH,
wherein, when the first PDSCH comprises a random access response, an ACK/NACK to the first PDSCH or the first cell is determined as discontinuous transmission (DTX) or NACK.

2. The method according to claim 1, wherein the wireless communication system is a frequency division duplex (FDD) system, and
wherein the specific time interval corresponds to one subframe.

3. The method according to claim 1, wherein the wireless communication system is a time division duplex (TDD) system, and
wherein the specific time interval corresponds to one or more subframes.

4. The method according to claim 1, further comprising receiving a physical downlink control channel (PDCCH) for scheduling the first PDSCH through the first cell,
wherein, when the PDCCH is masked with an identifier for random access, a power control command included in the PDCCH is not applied to a power for transmission of the control signal.

5. The method according to claim 4, wherein the power for transmission of the control signal is determined using a total number of received transport blocks, and
wherein, when the PDCCH is masked with the identifier for random access, the number of transport blocks received through the first PDSCH is excluded from calculation of the total number of the received transport blocks.

6. A user equipment (UE) for transmitting a signal in a wireless communication system in which a plurality of cells comprising a first cell and a second cell are aggregated, the UE comprising:
a radio frequency (RF) unit; and
a processor, wherein the processor is configured to:
receive a first physical downlink shared channel (PDSCH) through the first cell and a second PDSCH through the second cell in a specific time interval via the RF unit, and
transmit an control signal indicting an acknowledgement (ACK)/negative acknowledgment (NACK) response to the first PDSCH and an ACK/NACK response to the second PDSCH via the RF unit, and
when the first PDSCH comprises a random access response, an ACK/NACK to the first PDSCH or the first cell is determined as discontinuous transmission (DTX) or NACK.

7. The UE according to claim 6, wherein the wireless communication system is a frequency division duplex (FDD) system, and
wherein the specific time interval corresponds to one subframe.

8. The UE according to claim 6, wherein the wireless communication system is a time division duplex (TDD) system, and
wherein the specific time interval corresponds to one or more subframes.

9. The UE according to claim 6, wherein the processor is further configured to receive a physical downlink control channel (PDCCH) for scheduling the first PDSCH through the first cell via the RF unit, and
wherein, when the PDCCH is masked with an identifier for random access, a power control command included in the PDCCH is not applied to a power for transmission of the control signal.

10. The UE according to claim 9, wherein the power for transmission of the control signal is determined using a total number of received transport blocks, and
wherein, when the PDCCH is masked with the identifier for random access, the number of transport blocks received through the first PDSCH is excluded from calculation of the total number of the received transport blocks.
